(19) United States
(12) Patent Application Publication
(10) Pub. No.: US 2015/0075726 A1
(43) Pub. Date: Mar. 19, 2015

(54) ROMAN SHADE TYPE BLIND CLOTH

(71) Applicant: WINPLUS CO., LTD, Chungcheongbuk-do (KR)

(72) Inventor: Tae-Woong Byun, Daejeon (KR)

(21) Appl. No.: 14/386,776

(22) PCT Filed: Apr. 15, 2013
(86) PCT No.: PCT/KR2013/003157

§ 371 Date: Sep. 19, 2014

(30) Foreign Application Priority Data
Apr. 16, 2012 (KR) 10-2012-0039218
May 31, 2012 (KR) 10-2012-0058441
May 31, 2012 (KR) 10-2012-0058442

(51) Int. Cl. E06B 9/26; E06B 9/38

(52) U.S. Cl. CPC E06B 9/26; E06B 9/38
USPC 160/84.04

(57) ABSTRACT

Disclosed is a Roman shade type blind including: a front blind cloth with the upper end thereof fixed to a frame and the lower end thereof fixed to a weight part; a back blind cloth with the upper end thereof fixed to a winding-rod rotatably mounted in the frame and the lower end thereof fixed to the weight part; and a cord line passing the back side of the front blind cloth with the upper end thereof fixed to the winding-rod and the lower end thereof fixed to the weight part, wherein the blind cloth is woven so as to have a set of two or more rings arranged repeatedly in the back side of the front blind cloth with a given interval and to integrally have the cord line inserted into the rings, the rings of the ring set having a given interval, so that pulling the cord line causes the parts of the blind cloth between the sets of the rings to be folded forward so as to form loops of a given length.

### CROSS-REFERENCE TO RELATED APPLICATION

This application claims under 35 U.S.C. §119(a) the benefit of Korean Patent Application No. 10-2012-0039218 filed on Apr. 16, 2012, Korean Patent Application No. 10-2012-0058441 filed on May 31, 2012 and Korean Patent Application No. 10-2012-0058442 filed on May 31, 2012, the entire contents of which are incorporated herein by reference.

### TECHNICAL FIELD

The present invention relates to a Roman shade type blind in which loops are formed consecutively on a blind cloth, and more particularly, to a method for producing a Roman shade type blind cloth, a blind cloth made by the method and a blind using the blind cloth, in which the blind is assembled by easily adjusting an interval between loops and a width of a loop that is formed on an upper side of a weight to which a lower end of the blind cloth is fixed.

Further, the present invention relates to a Roman shade type blind cloth and a blind using the same, in which the blind cloth on a back surface of which a ring is formed is woven as double layers so that even though a ring portion is dented by pulling a cord line when the cord line inserted into a ring is wound or unwound around a winding-rod, the dented portion of the ring portion is not to be exposed outside.

Further, the present invention relates to a device for adjusting a length of a cord line of a Roman shade type blind and a device for fixing thereof, in which one end of the cord line is fixed to the winding-rod together with roll-up fabric and the other end thereof is fixed to the weight so as to form loops on the fabric, allowing the length of the cord line to be adjusted and the cord line to be fixed easily.

### BACKGROUND ART

Generally, a curtain or blind is arranged on a window or an exit of a building and is used for shielding sunlight, blocking prying eyes from outside, proofing sound, keeping warm and the like. In addition to these purposes, the curtain or blind is used as an important factor of interior decoration for improving interior beauty by means of combinations of colors matching with an inside wall or a window glass.

The curtain or blind is classified and used variously depending on its shape as a general type curtain that is unfolded to both sides from a center and folded reversely, a vertical blind that is divided into a plurality of pieces wherein an inclination angle of each piece can be adjusted, a roll screen blind in which a blind cloth of a layer or double layers is wound or unwound around a winding-rod, and a Roman shade curtain that is folded wholly while a curtain cloth is sub-folded vertically by a winding operation of a cord line that adjusts a length of the curtain.

FIG. 1 is an exploded-perspective view illustrating one of a conventional Roman shade type blind and FIGS. 2a and 2b are sectional views of FIG. 1 in a longitudinal direction wherein moulds 102 are arranged at a predetermined interval on a blind cloth 101 to be surrounded thereby depending on a length and width of a loop 104 desired to be formed and then the mould 102 surrounded by the blind cloth 101 is inserted into an insertion groove 103a formed through one end of a loop-forming bar 103 to be fixed thereto.

Next, a protrusion 106a of a ring 106 into which the cord line 105 is inserted is fitted into another insertion groove 103b that is exposed to the outside of the loop-forming bar 103, one end of the cord line 107 is fixed to a weight 107 to be fixed to a lower end of the blind cloth 101, and then the cord line 105 is passed through the ring 106 inserted into the insertion groove 103b of the loop-forming bar 103 and a remote end of the cord line 105 is fixed to the winding-rod 108, thereby completing an assembly thereof.

Accordingly, when the cord line 105 is unwound fully from the winding-rod 108, as shown in FIG. 2a, the blind cloth is loosened due to a self-weight of the weight 107 and thus the loop 104 is not formed on the blind cloth 101. That is, in a state where the blind cloth 101 is unfolded fully as shown in FIG. 2a, the blind cloth covers fully a window thereby to shield the interior from outside.

Under this state, when a user pulls an adjusting-line 109 to rotate the winding-rod 108, the loop 104 is formed by the blind cloth 101 disposed on the loop-forming bar 103 located firstly from the weight 107 since the cord line 105 is inserted into each ring 106 while one end of the cord line 105 is fixed to the weight 107. After that, when the cord line 105 is wound around the winding-rod 108 by pulling continuously the adjusting-line 109, a second loop 104 is formed by the blind cloth 101 disposed on the loop-forming bars 103 that are firstly and secondly located, as shown in FIG. 2b.

However, the Roman shade type blind as configured above has several problems as followings. In order to form consecutively the loops, a loop-forming bar, a mould and a ring need to be used necessarily, thereby increasing the number of components, decreasing an assembly property for producing the blind and increasing manufacturing cost therefrom. Further, the weight of the blind cloth becomes heavy with using the loop-forming bar and the mould and thus loads are applied to the winding-rod around which the blind cloth is wound, therefore the boss of an end bracket for supporting the winding-rod is to be broken without sustaining a total weight of the blind cloth, causing fatal damage. Meanwhile, the insertion grooves for the moulds are formed on a front surface of the blind cloth and thus unnecessary lines are displayed thereon, thereby limiting an implementation of various designs. Furthermore, cord lines of several strands for forming the loops on a loop forming fabric are exposed to a back surface of the loop forming fabric and thus the cord lines are exposed while the blind is lowered to shield fully a window, therefore children may wind mischievously the cord line on their neck, causing a safety accident.

Further, as shown in FIGS. 3a to 3c, a conventional weight is provided with a lower rod 71 in a circular shape to which each lower end of the front and rear blind cloths is fixed; lower rod caps 72 on which fitting protrusions 72a are protruded, which are fitted into both ends of the lower rod 71, respectively, so that the caps are not to be split toward both sides of the lower rod 71 and is to be centered thereon; a lower bar 73 that is fitted into the outside of the lower rod 71 in a length direction to balance the center of gravity thereof and cover the lower rod 71; and lower rod caps 74 on each of which an axial rod 741 is protruded to balance a rotation center of the lower rod 71 and which are fitted into both ends of the lower bar 73, respectively, such that the lower rod 71 is not to be split to one side. At this time, the cord line that has passed through the ring formed on aback surface of a front blind cloth is fixed integrally to a lower end of a rear blind cloth and then the rear blind cloth is fixed to the lower rod 71.

However, in a state before the front and rear blind cloths are assembled to the lower rod, the cord line passes through the ring on the front blind cloth and the remote end thereof is fixed to the lower end of the rear blind cloth, and thus the lower ends of the front and rear blind cloths are not separated, but they are separated by the distance from the final ring of the lower end through which the cord line passes to the lower end of the rear blind cloth. Under the states of the front and rear blind cloths as described above, when the lower ends of the front and rear blind cloths are to be fitted into the lower rod 71 and assembled thereto, the front and rear blind cloths need certainly to be fitted simultaneously into the lower rod 71 since they need to be fitted from one side of the lower rod 71. That is, as described above, the separation between the lower ends of the front and rear blind cloths is limited by the cord line and thus only anyone of the front and rear blind cloths cannot be fitted firstly into the lower rod 71 and assembled thereto.

Accordingly, it is fastidious and difficult to assemble the front and rear blind cloths and the lower rod 71, thereby making the assembly thereof to be inconvenient and decreasing production efficiency. Especially the cord line that is fixed integrally to the rear blind cloth is caught on the lower rod 71 when the rear blind cloth is fitted into the lower rod 71, to be broken or separated, thereby making the assembly to be difficult.

### DISCLOSURE

### Technical Problem

The present invention has been proposed to solve the drawbacks of a related art and one object of the present invention is to make an appearance of a blind to be beautiful by forming the loops evenly on a front surface of the blind without using a separate loop-forming bar.

Another object of the present invention is to adjust freely the intervals between loops to be formed while the blind is assembled such that several rings into which a cord line is inserted are woven integrally on a back surface of the front blind cloth with maintaining a predetermined interval while the front blind cloth is woven.

Further another object of the present invention is to adjust freely the length and the intervals between loops to be formed while the blind is assembled such that the rings into which the cord line is inserted are formed wholly on a back surface of the front blind cloth so as not to entangle the wefts with the warps, or such that the rings are woven integrally with maintaining a predetermined interval while the blind cloth is woven.

Still another object of the present invention is to minimize the load applied to a boss of an end bracket for supporting both ends of a winding-rod and prevent a phenomenon in advance where a boss is broken when the blind cloth is wound or unwound around the winding-rod by pulling an adjusting-line.

Further still another object of the present invention is to improve convenience of assembly operation and production efficiency by improving the configuration of the weight such that the lower rod is divided into two parts and the front and rear blind cloths are assembled to two lower rods, respectively.

Another object of the present invention is to maintain constantly a front surface of the blind cloth as a dense state and a flat state by weaving the part of a back surface of the blind cloth where the rings are formed as double layers even through the texture on which the rings are formed is not dense.

### TECHNICAL SOLUTION

According to a first aspect of the present invention, a Roman shade type blind cloth is provided, wherein two or more ring sets into which a cord line is inserted are woven integrally to be formed repeatedly along a vertical direction and a horizontal direction within a predetermined interval on a back surface of the blind cloth when weaving a fabric. In the Roman shade type blind cloth according to a first aspect of the present invention the ring has a predetermined width b and a weft is woven not to be entangled with a warp by the width b of the ring when weaving the blind cloth.

According to a first aspect of the present invention, a blind using a Roman shade type blind cloth is provided, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that the blind cloth is woven such that two or more ring sets are formed repeatedly within a predetermined interval l on a back surface of the front blind cloth, having an interval of a predetermined distance L₂ wherein the cord line that has been inserted into the ring is woven integrally with a blind cloth fabric and the blind cloth between the ring sets is folded frontward by pulling the cord line to form a loop of a predetermined length L₂/2.

Further, according to a first aspect of the present invention, a blind using a Roman shade type blind cloth is provided, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that the blind cloth is woven such that two or more ring sets are formed repeatedly within a predetermined interval l on a back surface of the front blind cloth, having an interval of a predetermined distance L₂ wherein the cord line is passed through two or more rings in turn and the blind cloth between the ring sets is folded frontward by pulling the cord line to form a loop of a predetermined length L₂/2.

According to a second aspect of the present invention, a Roman shade type blind cloth is provided, wherein all of wefts are woven not to be entangled with warps by the width b of the ring, such that rings into which a cord line is inserted are consecutively in a vertical direction on a back surface of the blind cloth.

Further, according to a second aspect of the present invention, a blind using a Roman shade type blind cloth is provided, wherein an upper end of a blind cloth is fixed to a frame and a lower end thereof is fixed to a weight; and a cord line that operates the front blind cloth to form a loop passes through a back surface of the blind cloth and the upper end thereof is fixed to a winding-rod and the lower end thereof is fixed to the weight, is characterized in that all of wefts are woven not to be entangled with warps by a width b of the ring such that rings are formed consecutively on a back surface of the blind cloth in a vertical direction, and then the cord line is inserted into the rings by a predetermined length (L₁) of the rings and a distance between the rings is maintained with a predetermined length (L₂), and the blind cloth between the rings is folded frontward by pulling the cord line to form a loop of a predetermined length L₂/2.

According to a third aspect of the present invention, a Roman shade type blind cloth is provided, wherein wefts are woven not to be entangled with warps by the width b of the ring such that rings into which a cord line is inserted are formed on a back surface of the blind cloth, is characterized in that pockets consisting of internal fabric and external fabric are formed consecutively on the blind cloth and one or more rings are formed on the external fabric that is disposed toward a window.

Further, according to a third aspect of the present invention, a blind using a Roman shade type blind cloth is provided, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that pockets consisting of internal fabric and external fabric are formed repeatedly on the front blind cloth and wefts are woven not to be entangled with warps by a width b of the ring such that one or more ring sets into which the cord line is inserted are formed within a predetermined interval l on the external fabric, and then the cord line is passed through one or more rings in turn and the blind cloth between the ring sets is folded frontward by pulling the cord line to form a loop of a predetermined length L₂/2.

Further, according to a third aspect of the present invention, a blind using a Roman shade type blind cloth is provided, wherein an upper end of a blind cloth is fixed to a frame and a lower end thereof is fixed to a weight; and a cord line that operates the blind cloth to form a loop passes through a back surface of the blind cloth and the upper end thereof is fixed to the winding-rod and the lower end thereof is fixed to the weight, is characterized in that pockets consisting of internal fabric and external fabric are formed repeatedly on the blind cloth and wefts are woven not to be entangled with warps by a width b of the ring such that one or more ring sets into which the cord line is inserted are formed within a predetermined interval l on the external fabric, and then the cord line is passed through one or more rings in turn and the blind cloth between the ring sets is folded frontward by pulling the cord line to form a loop of a predetermined length L₂/2.

In the Roman shade type blind cloth according to a first to a third aspects of the present invention, fabric of a blind cloth may be woven integrally by supplying a cord line as a warp and fitting the cord line into a ring when the ring is formed while the blind cloth is woven.

According to a fourth aspect of the present invention, the ring into which the cord line is inserted has a predetermined width b when the Roman shade type blind cloth is woven, and warps are woven not to be entangled with wefts by the width b of the ring. Further, rings are formed by arranging distances between warps which are not entangled with wefts to be increased gradually when weaving the blind cloth.

According to a fifth aspect of the present invention, a device for adjusting a length of a cord line of a Roman shade type blind and a device for fixing thereof is provided, comprising: a housing at a center of which an insertion hole is formed horizontally to be fixed to a winding-rod and a weight, respectively; and an adjusting-rod that is inserted into the insertion hole formed on the housing wherein the length of the cord line is fixed by forcibly putting an adjusting-rod into the insertion hole while the cord line is supported, or the length of the cord line is adjusted by rotating the adjusting-rod.

### Advantageous Effects

The present invention has the following several advantages as compared to a conventional Roman shade type blind.

First, the rings are integrally woven on a back surface of a front blind cloth to freely adjust the length and width of a loop desired to form even without using a separate loop-forming bar, molds, and ring as in a related art. Thus, assembly property according to production of the blind is maximized, thereby significantly decreasing the production costs and cheaply supplying the Roman shade type blind.

Second, weight of a blind cloth is minimized without using a loop-forming bar and molds and thus load applied to a winding-rod around which the blind cloth is wound can also be minimized, thereby basically resolving a phenomenon that a boss of end bracket for supporting the winding-rod is broken without sustaining the whole weight of the blind cloth.

Third, a loop-forming bar is not used, differently from the related art, and thus unnecessary lines are not exposed on the front surface of a front blind cloth, thereby achieving various shaped designs.

Fourth, as a rear blind cloth is applied, a phenomenon in which children could wind a cord line around their neck is prevented, thereby obtaining a function of preventing in advance safety accident of children due to the cord line.

Fifth, a structure of a weight is improved, thereby enhancing the convenience of assembling operation and production efficiency.

Sixth, when loops are formed by raising a front blind cloth, the loops are not collected in one place, thereby forming uniform loops.

Seventh, while the blind is assembled by passing a cord line into the rings formed on a back surface of a blind cloth, as the intervals between loops are widen gradually downwardly, lengths of the loops that are formed by raising the blind cloth are varied, respectively, thereby diversely producing interior environments.

Eighth, since a portion at which a ring of a Roman shade type blind cloth is formed is woven as double layers, even if the ring portion is deformed due to load applied thereon under the circumstance that the cord lines have sequentially passed through the rings, a surface positioned inside a window covers the deformed ring portion, thereby preventing in advance a phenomenon in which the ring portion is projected or it protrudes toward the front side.

Ninth, a ring into which a cord line is inserted is formed at a predetermined region of warp with a set color and stripe patterns are displayed on weft with desired color. Thus, it is possible to display various designs with respect to the whole length of the warp and to weave cloth with other designs as much as the length that a buyer or a consumer desires, thereby preventing the occurrence of stock in advance.

Tenth, all warps of the several hundreds or thousands of strands with a set color are fitted into a heald eye, thereby preventing in advance a phenomenon in which warp is erroneously fitted into a heald eye as in the related art, as well as allowing for prompt manufacturing thereof.

Eleventh, an operation of fixing the cord line is completed only by leaving the cord line at an inlet of the housing and pushing the adjusting-rod therein, and then fitting it into a mounting groove formed on a winding-rod or a weight, thereby doubling a working efficiency and reducing the production costs.

Twelfth, in a case where a length of the cord line that is fixed is long, the length of the cord line can be adjusted by rotating an adjusting-rod, thereby preventing unwanted effects of throwing the cord line away by cutting it and re-assembling it.

### BRIEF DESCRIPTION OF THE DRAWINGS

FIG. 1 is an exploded-perspective view illustrating schematically a Roman shade type blind according to a related art;

FIGS. 2a and 2b are longitudinal sectional views of an assembling state of FIG. 1, wherein FIG. 2a is a view illustrating a state where a blind cloth is unfolded fully and FIG. 2b is a view illustrating a state where a part of the blind cloth is wound around a winding-rod and loops are formed at an upper side of a weight;

FIGS. 3a to 3c are views illustrating the weight as shown in FIGS. 2a and 2b, wherein FIG. 3a is an exploded-perspective view, FIG. 3b is a longitudinal sectional view of an assembly and FIG. 3c is a side-sectional view of the assembly;

FIG. 4 is a perspective view illustrating a Roman shade type blind of a double layer according to a first aspect of the present invention, wherein a front and rear blind cloths are fixed simultaneously to a weight;

FIG. 5 is a rear view of a front blind cloth to which an embodiment according to a first aspect of the present invention is applied;

FIGS. 6a and 6b are longitudinal sectional views of FIG. 4, wherein FIG. 6a is a view illustrating a state where the weight to which the lower ends of the front and rear blind cloths are fixed is disposed at the bottom dead point and FIG. 6b is a view illustrating a state where a loop is formed on the front blind cloth by pulling an adjusting-line;

FIG. 7a is a detailed-view illustrating a first embodiment of “A” part of FIG. 5 and FIG. 7b is a detailed-view illustrating a second embodiment of “A” part of FIG. 5;

FIG. 8a is a detailed-view illustrating a third embodiment of “A” part of FIG. 5 and FIG. 8b is a detailed-view illustrating a fourth embodiment of “A” part of FIG. 5;

FIG. 9a is a detailed-view illustrating a fifth embodiment of “A” part of FIG. 5 and FIG. 9b is a detailed-view illustrating a sixth embodiment of “A” part of FIG. 5;

FIGS. 10a and 10b are longitudinal sectional views illustrating a Roman shade blind of an embodiment according to a first aspect of the present invention in which two weights are fixed to the front and rear blind cloths, respectively, wherein FIG. 10a is a view illustrating a state where the weights to which the lower ends of the front and rear blind cloths are fixed, respectively, are disposed at the bottom dead point and FIG. 10b is a view illustrating a state where a loop is formed on a front blind cloth by pulling an adjusting-line;

FIGS. 11a to 11c are views illustrating a weight of a Roman shade blind of a double layer according to a first aspect of the present invention, wherein FIG. 11a is an exploded-perspective view, FIG. 11b is a longitudinal sectional view of an assembly and FIG. 11c is a side-sectional view of an assembly;

FIG. 12 is a view illustrating an embodiment of a blind cloth woven as oblique line patterns according to a first aspect of the present invention;

FIGS. 13a and 13b are rear views illustrating another embodiment according to a first aspect of the present invention, wherein FIG. 13a is a view illustrating a state where a cord line passes completely through a ring and FIG. 13b is a view illustrating a state where the cord line passes through an intermediate of the ring;

FIG. 14 a rear perspective view illustrating an embodiment according to a second aspect of the present invention;

FIG. 15 is a rear view illustrating a blind cloth to which an embodiment according to a second aspect the present invention is applied;

FIGS. 16a and 16b are longitudinal sectional views of FIG. 14 wherein FIG. 16a is a view illustrating a state where the weight to which the lower end of the blind cloth is fixed is disposed at the bottom dead point and FIG. 16b is a view illustrating a state where a loop is formed on the blind cloth by pulling the adjusting-line;

FIG. 17a is a detailed-view illustrating a first embodiment of “A” part of FIG. 15 and FIG. 17b is a detailed-view illustrating a second embodiment of “A” part of FIG. 15, FIG. 17c is a detailed-view illustrating a third embodiment of “A” part of FIG. 15 and FIG. 17d is a detailed-view illustrating a fourth embodiment of “A” part of FIG. 15;

FIG. 18a is a detailed-view illustrating a fifth embodiment of “A” part of FIG. 15 and FIG. 18b is a detailed-view illustrating a sixth embodiment of “A” part of FIG. 15;

FIGS. 19a and 19b are rear views illustrating the blind cloth to which another embodiment according to a second aspect of the present invention is applied, wherein FIG. 19a is a view illustrating a state where a cord line passes completely through a ring and FIG. 19b is a view illustrating a state where the cord line passes through an intermediate of the ring;

FIGS. 20a and 20b are rear views illustrating the blind cloth to which another embodiment according to a second aspect of the present invention is applied, wherein FIG. 20a is a view illustrating a state where a cord line passes through the rings at a predetermined interval of same distance and FIG. 20b is a view illustrating a state where the cord line passes through the rings at gradually increased intervals downwardly;

FIG. 21 is a perspective view illustrating a blind cloth of an embodiment according to a third aspect of the present invention;

FIG. 22 is a perspective view illustrating a blind cloth of another embodiment according to a third aspect of the present invention;

FIG. 23 is a perspective view illustrating a blind cloth of further another embodiment according to a third aspect of the present invention;

FIGS. 24a and 24b are perspective views illustrating a state where a tension band is fitted into a blind cloth;

FIG. 25 is a sectional view illustrating a pocket where a tension band is fitted into a blind cloth as shown FIGS. 24a, 24b;

FIGS. 26a and 26b are side views illustrating an assembly of a blind to which the front and rear blind cloths of a blind device according to a third aspect of the present invention are applied;

FIGS. 27a and 27b are side views illustrating an assembly of a blind to which the front blind cloth of a blind device according to a third aspect of the present invention is applied;

FIG. 28 is a rear view illustrating an embodiment of a blind cloth according to a fourth aspect of the present invention;

FIG. 29 is a view illustrating a state where the blind cloth of FIG. 28 is cut depending on a width of a window to be rotated at an angle of 90°;

FIG. 30 is a view illustrating another embodiment of a blind cloth according to a fourth aspect of the present invention;

FIG. 31 is a rear view illustrating further embodiment of rings of a blind cloth according to a fourth aspect of the present invention;

FIG. 32 is a view illustrating a state where loops are formed when the blind cloth of FIG. 31 is raised;

FIG. 33 is a view illustrating a state where one end of roll-up fabric of a conventional Roman shade type blind is fixed to a winding-rod and the roll-up fabric is unfolded completely;

FIG. 34 is an enlarged-longitudinal sectional view illustrating a state where each end of a cord line, roll-up fabric and loop forming fabric is fixed to a weight of a conventional Roman shade type blind;

FIG. 35 is an exploded-perspective view illustrating main components of a device according to a fifth aspect of the present invention;

FIG. 36 is a perspective view illustrating an assembly of the device of FIG. 35;

FIG. 37 is a longitudinal sectional view of FIG. 36;

FIG. 38 is a view illustrating a state where the device according to a fifth aspect of the present invention is installed to the weight;

FIGS. 39a and 39b are longitudinal sectional views illustrating the devices according to a fifth aspect of the present invention are fixed to a winding-rod and a weight, respectively; and

FIG. 40 is a perspective view illustrating an adjusting-rod as another supporting means for the device according to a fifth aspect of the present invention.

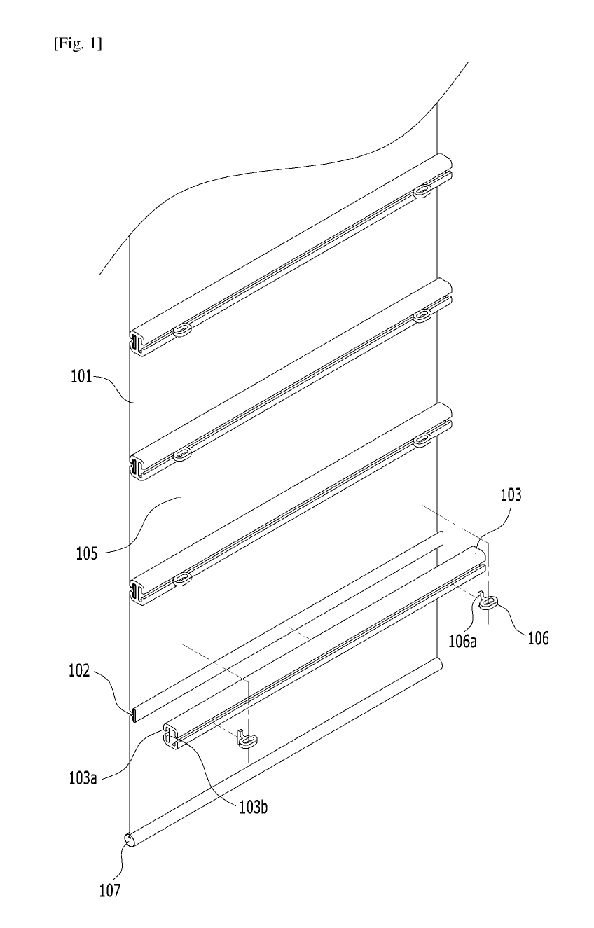

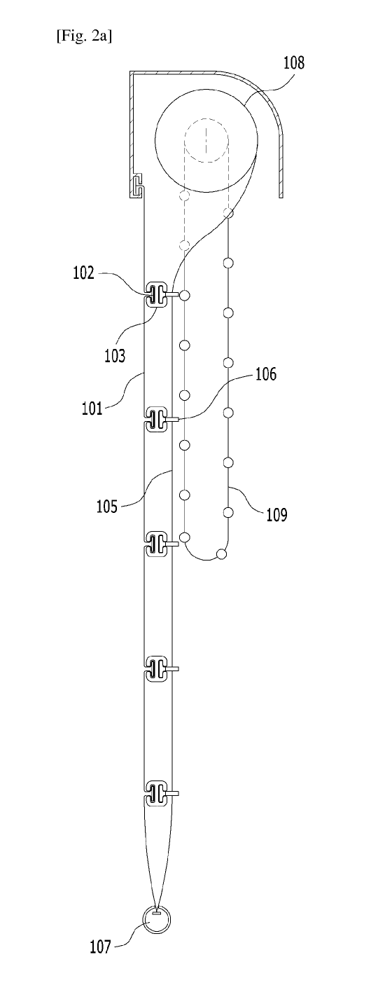

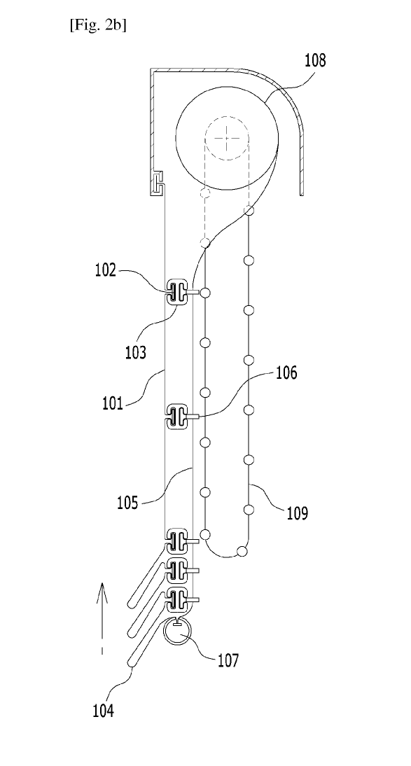

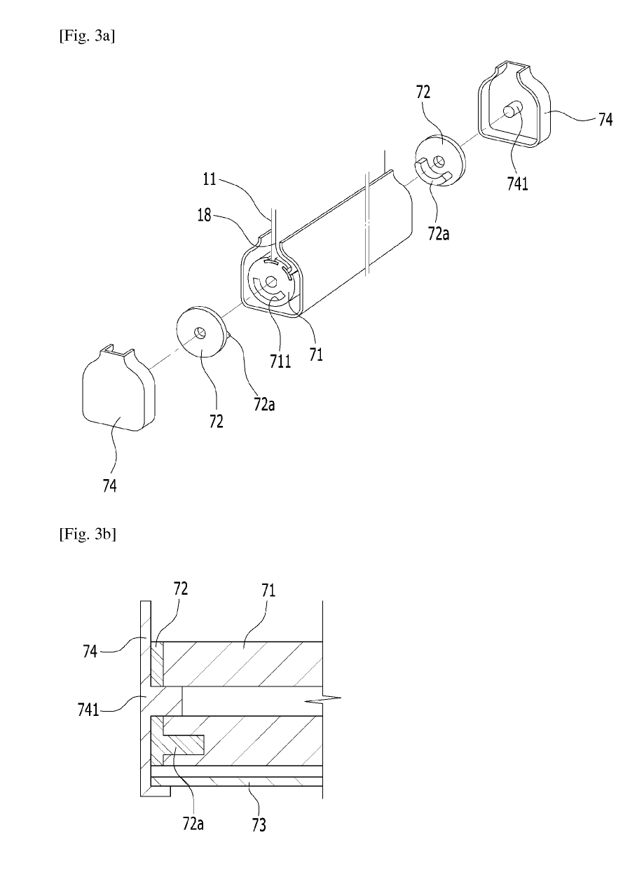

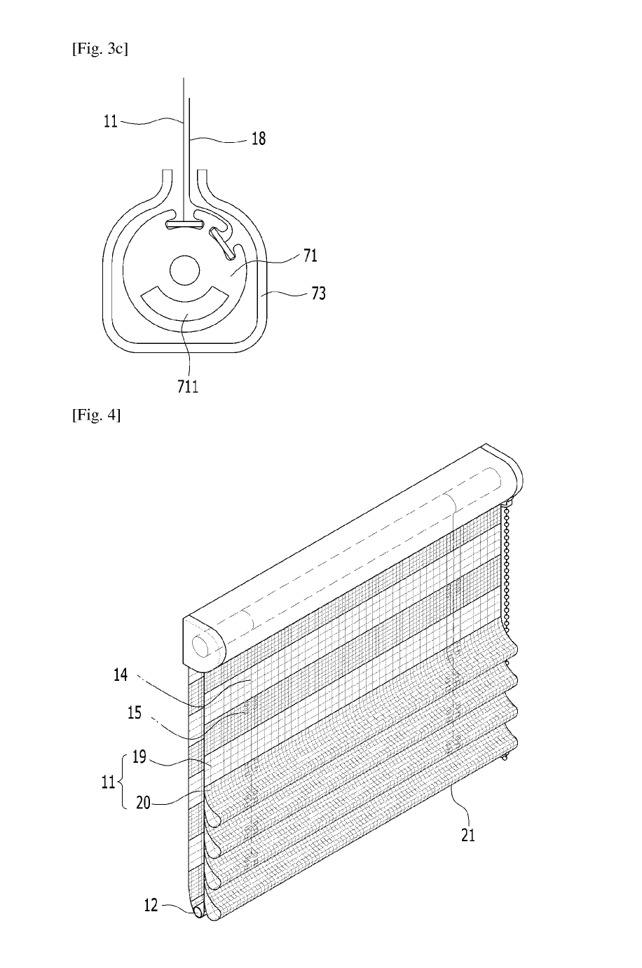

### BEST MODE FOR THE INVENTION

The objects, features and advantageous effects as stated above will be obvious through the following embodiments of the present invention, which will be described with reference to the accompanying drawings.

The special configurations and functional descriptions are merely exemplary for describing the embodiments according to the present invention, and further the embodiments of the present invention may be replaced by various modifications, and thus should not be construed as limiting thereto.

The embodiments according to a concept of the present invention may be changed variously and have various types and thus the special embodiments will be illustrated in the drawings and described in the specification. However, the embodiments according to a concept of the present invention are not limited to the specifically disclosed types and thus it should be understood that it includes all modifications and equivalents or replacements included within a spirit and a scope of the present invention.

Although terms like a first and/or a second are used to describe various components, but the components are not limited to these terms. These terms are used only to differentiate one component from another one, for example, the first component can be referred to as the second component, or the second component can be referred to as the first component, without departing from the scope of the present invention.

It also should be understood that when it is stated that one component is “connected” or “coupled” to another component, even though the one component may be directly connected or coupled to the another component, but there may be other components between them. However, it has to be understood that when it is stated that one component is “directly connected” or “directly coupled” to another component, there is no intermediate component between them. The terms used for describing a relation among other components, that is, “between”, “right between”, “adjacent to” or “directly adjacent to” have to be construed similarly.

The terminology used herein is for the purpose of describing particular embodiments only and is not intended to be limiting to the embodiments. As used herein, unless otherwise defined, the singular forms “a,” “an” and “the” are intended to include the plural forms as well. Unless the context indicates otherwise, it will be further understood that the terms “comprising” and/or “having” when used in this specification, specify the presence of stated features, integers, steps, operations, elements, and/or components, but do not preclude the presence or addition of one or more other features, integers, steps, operations, elements, components, parts or combination thereof.

All terms including technical or scientific terminology used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, reference numerals will now be made in detail to various embodiments of the present invention, examples of which are illustrated in the accompanying drawings and described below. In the drawings, the same reference numerals refer to the same components.

Hereinafter, the preferred embodiments of the present invention will be described in detail referring to the drawings.

Firstly, a Roman shade type blind cloth and a blind device using the same according to a first aspect of the present invention will be described, referring to FIGS. 4 to 13b.

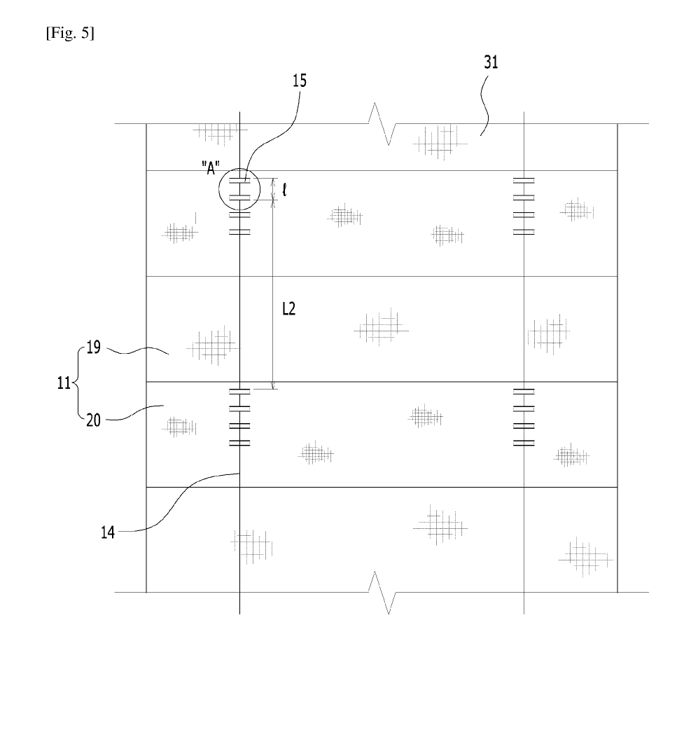

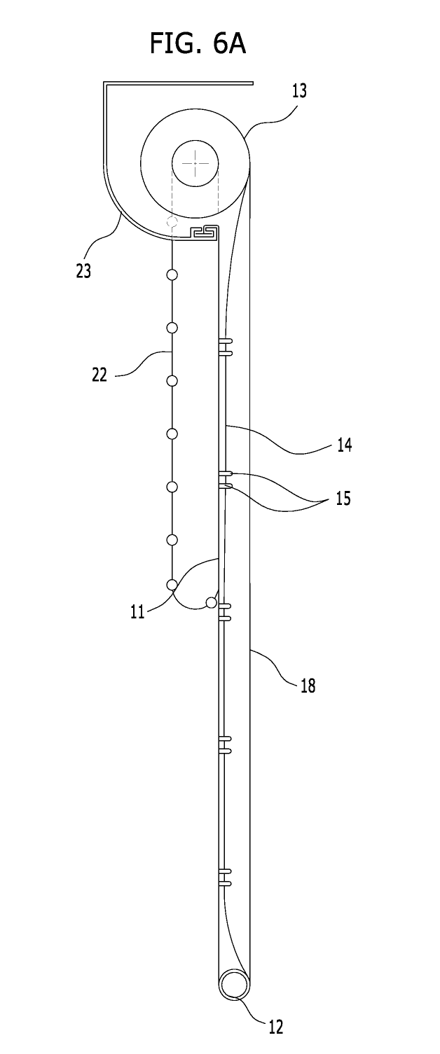

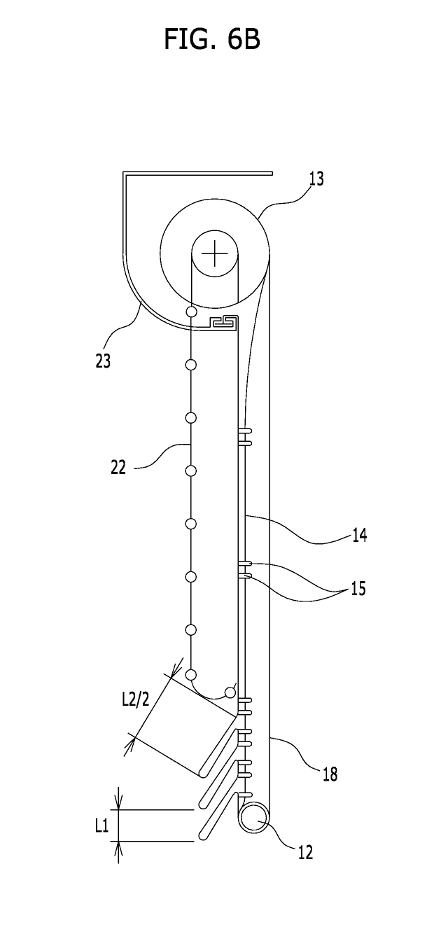

FIG. 4 is a perspective view illustrating a Roman shade type blind to which a Roman shade type blind cloth according to a first aspect of the present invention is applied, FIG. 5 is a rear view illustrating a front blind cloth to which an embodiment according to a first aspect of the present invention is applied and FIGS. 6a and 6b are longitudinal sectional views of FIG. 4.

According to an embodiment of a first aspect of the present invention, it is featured that a blind cloth 11 may be woven integrally such that two or more ring sets 15 into each of which a cord line 14 is inserted are formed repeatedly along a horizontal direction and a vertical direction within a predetermined interval l on a back surface of the blind cloth 11. Here, the description of “a blind cloth 11 may be woven integrally such that two or more ring sets 15 into each of which a cord line 14 is inserted are formed repeatedly within a predetermined interval l on a back surface of the blind cloth 11” means that the weft and the warp are woven in a case of a general weaving method, however, in a case of the ring set 15 of the present invention, the weft on which the ring set 15 is formed is woven not to be entangled with the warp by floating itself, thereby to form the ring set. Further, the description means that the weft and the warp are woven to be entangled in the region where the ring set is not formed between one ring set 15 and the adjacent ring set 15. Here, whether the interval between the ring sets is woven densely or sparsely is determined depending on material of fabric, thickness of fabric and whether the fabric is coated or not, etc.

According to another type of the blind cloth according to a first aspect of the present invention, the blind cloth may be woven integrally such that all of wefts within the given interval l on a back surface of the blind cloth 11 are woven not to be entangled with warps by floating them, thereby forming consecutively the rings 15. Here, the description of “the blind cloth may be woven integrally such that all of wefts within the set interval l on a back surface of the blind cloth 11 are woven not to be tangled with warps by floating them, thereby forming consecutively the rings 15” means that the rings are formed consecutively through all intervals between the rings without any gap therebetween, and that all of wefts within the given interval l are floated not to be entangled with the warps such that the wefts become the rings. That is, it can be cleared by understanding the difference between forming two or more ring sets 15 and forming consecutively a plurality of rings within the predetermined interval l as described above.

In a case of configuring a blind using the blind cloth according to a first aspect of the present invention as described above, the upper ends of a front and rear blind cloths 11, 18 are fixed to a frame 23 and a winding-rod 13, respectively, and lower ends of the front and rear blind cloths 11, 18 are fixed simultaneously to one weight 12, and a cord line 14 is passed through in turn two or more ring sets 15 disposed on a back surface of the front blind cloth 11 depending on an interval L₁ between loops to be formed and a length L₂/2 of a loop, and then one end of the cord line 14 is fixed to the weight 12 and the other end thereof is fixed to the winding-rod 13. Here, when both ends of the cord line 14 are fixed to the weight 12 and the winding-rod 13, respectively, a bonding agent or a knot method may be used. Further, the cord lines may be inserted into a fastening device provided with a male and female connection means to be fixed thereto so as to adjust easily a length of the cord line and fix efficiently the cord line.

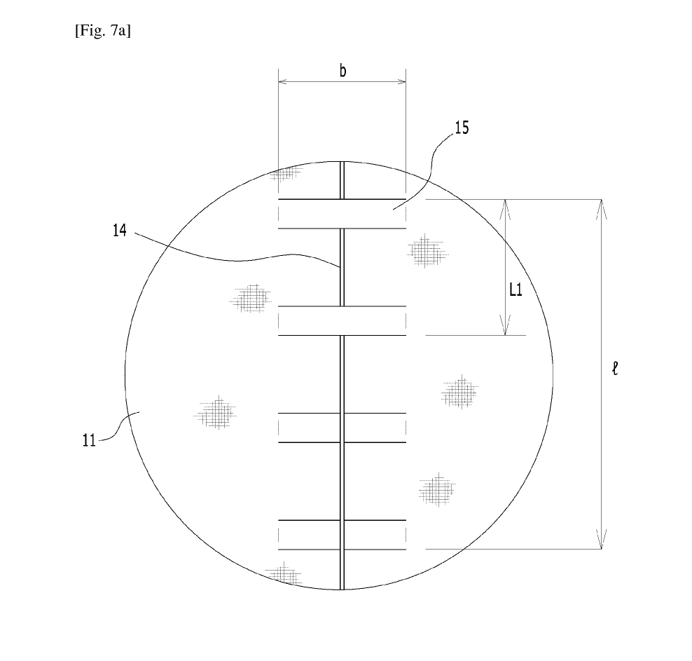

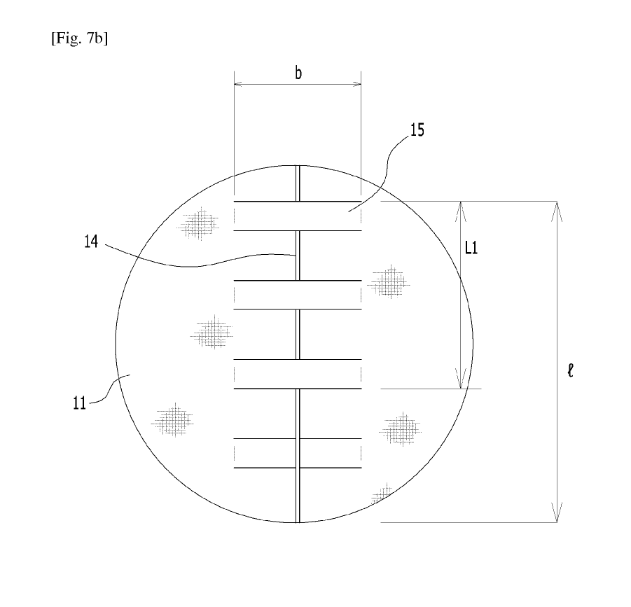

FIG. 7a is a detailed-view illustrating a first embodiment according to a first aspect of the present invention, and it shows a case where four ring sets 15 are formed within a predetermined interval l on a back surface of the front blind cloth, and the cord line 14 is passed through only two ring sets 15 thereby to determine the interval L₁ between loops. FIG. 7b is a detailed-view illustrating a second embodiment of “A” part of FIG. 5, and it shows a case where four ring sets 15 are formed within a predetermined interval l on a back surface of the front blind cloth, the cord line 14 is passed through three ring sets 15 thereby to determine the interval L₁ between loops. As described above, when the cord line 14 is inserted into each ring 15 formed along a vertical direction of the front blind cloth 11, the cord line 14 is passed through only two ring sets 15 that are adjacent up/downward when forming the interval L₁ between loops to be narrow. Unlike this, the cord line 14 is passed through three or more adjacent ring sets 15 when forming the interval L₁ between loops to be wide, thereby adjusting easily the interval between loops when assembling the blind.

The ring 15 may be fixed to a back surface of the front blind cloth 11 using a separate bonding means (bonding, high frequency, sewing and the like), but it may be advantageous in terms of production efficiency to form integrally the ring with the front blind cloth by weaving them integrally.

Further, when the ring 15 is formed while weaving the blind cloth, the fabric of the blind cloth may be woven integrally by supplying the cord line 14 as weft and inserting it into the ring 15.

Meanwhile, the loops are formed on the front blind cloth in the Roman shade type blind using the front blind cloth as described above without using a loop-forming bar, a mould and a ring. However, since the front blind cloth is woven of a relatively thin and soft fabric and the cord line is inserted into in turn two or more ring sets formed on a back surface of the front blind cloth at a predetermined interval, there may occur a case where the interval between loops is not maintained constantly.

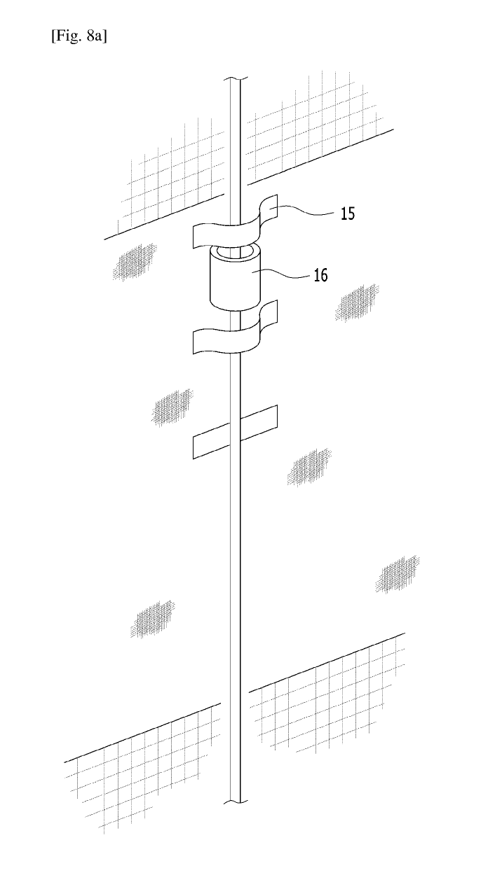

Accordingly, in another embodiment according to a first aspect of the present invention, as shown in FIG. 8a, an interval maintaining member 16 through which the cord line 14 passes may be fitted between one ring set 15 and another ring set 15 on a back surface of the front blind cloth 11, thereby maintaining the interval L₁ between loops constantly as the cord line 14 passes through one ring set 15, the interval maintaining member 16 and another ring set 15 in turn. That is, the interval maintaining member 16 is disposed between the ring sets 15 formed on a back surface of the front blind cloth 11 and the cord line 14 also passes the inside of the interval maintaining member 16 when the cord line 14 passes through the ring sets 15.

Further, another object of installing the interval maintaining member is as follows. That is, if the interval maintaining member 16 is not installed and only the cord line 14 is inserted to pass between one ring set 15 and another ring set 15, since the front blind cloth 11 is woven of a relatively thin and soft fabric, the interval between one ring set 15 and another ring set 15 is not maintained constantly and a part between the ring sets is folded. Accordingly, there may be a probability that the interval between loops cannot be maintained constantly and thus the interval maintaining member 16 is installed between one ring set 15 and another ring set 15 so as to prevent the above phenomenon in advance. In this case, it can be understood that the interval L₁ between loops is determined depending on the length and number of the interval maintaining member.

A shape of the interval maintaining member 16 that is applied to another embodiment according to a first aspect of the present invention may be a tube form of a circle, polygon (triangle, rectangle, pentagon, hexagon and the like), if necessary.

FIG. 8b is a view illustrating further another embodiment according to a first aspect of the present invention, wherein in a case of widening further the interval L₁ between loops, a plurality of interval maintaining member 16 may be installed on intervals between four ring sets 15, respectively, such that the cord line 15 is passed through the ring sets 15 and the interval maintaining members 16 in turn.

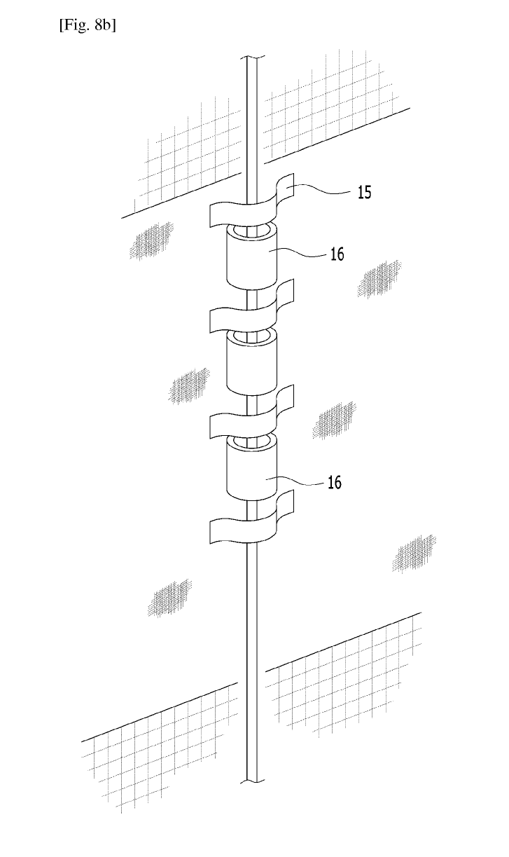

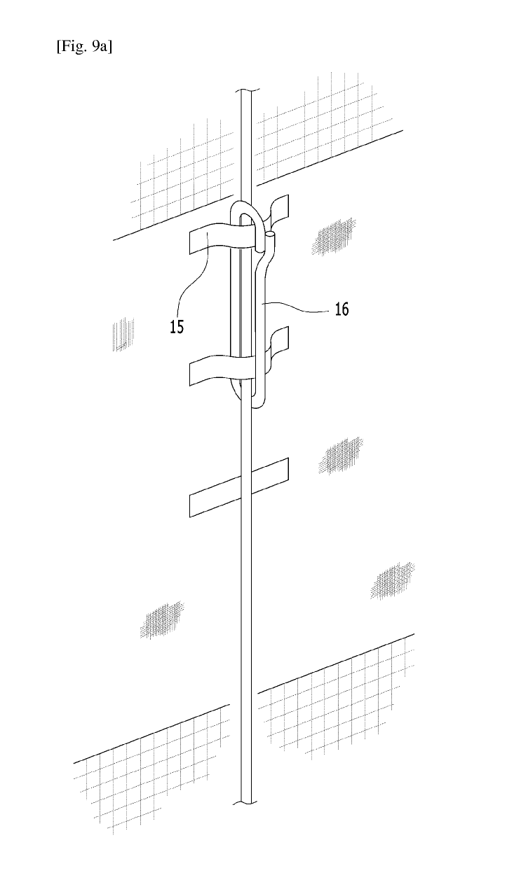

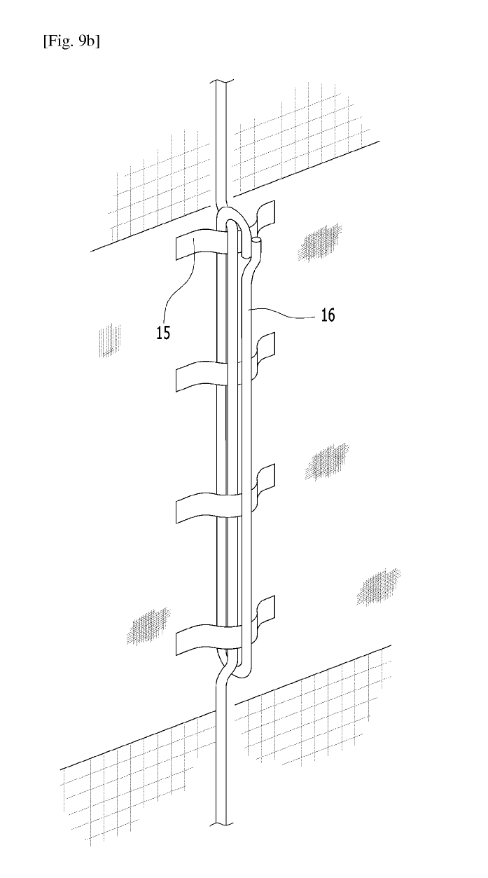

FIGS. 9a and 9b are views illustrating another embodiment according to a first aspect of the present invention, using another type of the interval maintaining member wherein the interval maintaining member 16 may be formed as a long ring pin-type one side of which is opened such that the ring set 15 is fitted and retracted therethrough, and the size of which is determined such that the interval maintaining member is fitted into two ring sets 15 as shown in FIG. 9a, or it is fitted into simultaneously four ring sets 15 as shown in FIG. 9b, by using a bend-molding or injection-molding method. At this time, the cord line 14 is passed through the interval maintaining member 16 of a ring pin type which is fitted into the ring sets 15, thereby connecting simply between the ring sets and, as a result, making a loop shape with being in contact with the interval maintaining member 16 when it is operated.

In each embodiment according to a first aspect of the present invention configured as described above, the rear blind cloth 18 is further arranged on a back surface of the front blind cloth 11 and the upper end of the rear blind cloth is fixed to the winding-rod 13 together with the cord line 14 and the lower end thereof is fixed to the weight 12 together with the cord line 14. As a result, it has advantageous effects to prevent children from winding mischievously the cord line 14 arranged on a back surface of the front blind cloth 11 on their neck and being suffocated in advance.

In a case where the front and rear blind cloths 11, 18 are arranged a light-transmitting part 19 and a light-shielding part 20 may be formed consecutively such that the interior is bright and well-ventilated without raising the front and rear blind cloths 11, 18. At this time, the ring sets 15 that are formed on a back surface of the front blind cloth 11 are woven as two or more within the set interval l on an upper side of the light-shielding part 20.

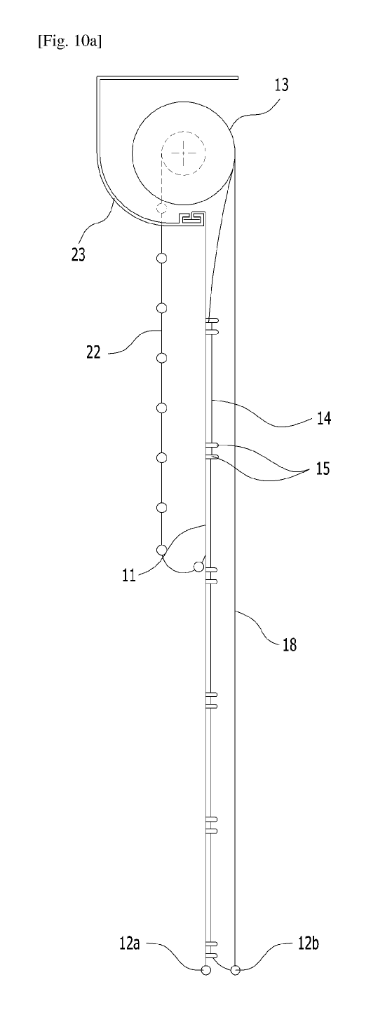

FIGS. 10a and 10b are views illustrating a Roman shade blind of a double layer of another embodiment according to a first aspect of the present invention wherein, two weights 12a, 12b may be fixed separately to each lower end of the front and rear blind cloths 11, 18. In this case, as described above, the cord line 14 is passed through two or more ring sets 15 disposed on a back surface of the front blind cloth 11 in turn and an upper end thereof needs to be fixed to the winding-rod 13 and the lower end thereof needs to be fixed to the weight 12b of the rear blind cloth 18.

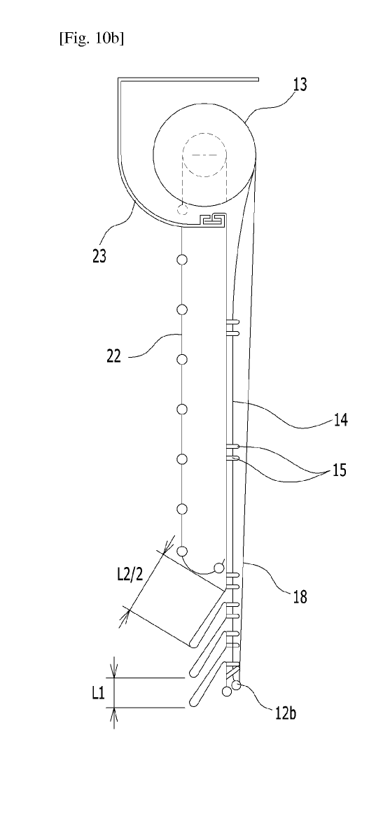

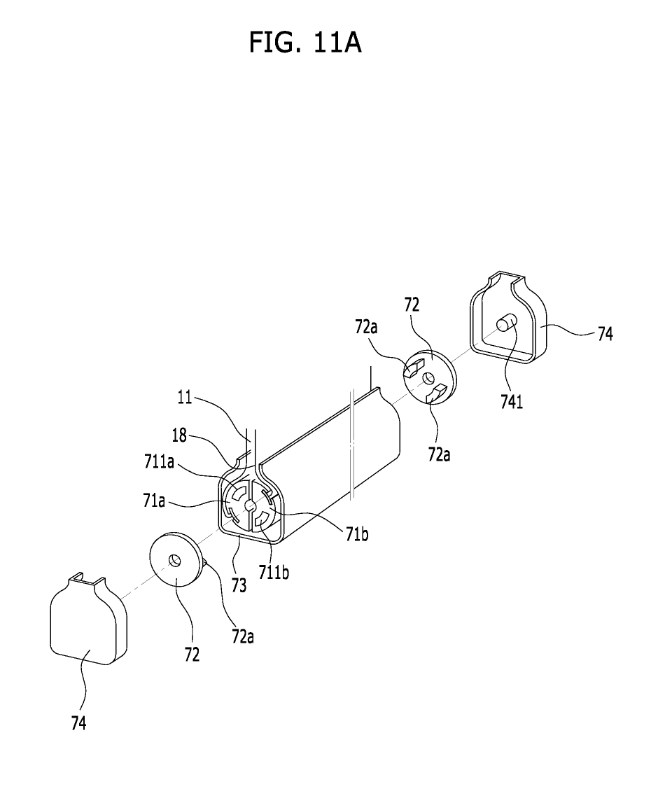

FIGS. 11a to 11c are views illustrating the weights 12 of a blind device of another embodiment according to a first aspect of the present invention, wherein each weight 12 is provided with two semicircular rods 71a, 71b that are divided, to which the lower ends of the front and rear blind cloths 11, 18 are fixed, respectively; a lower rod cap 72 on which two fitting protrusions 72a are protruded to face each other, which are fitted into assembly holes 711a, 711b of the respective semicircular rods 71a, 71b not to be separated to both sides and balance the center so as to maintain a circular shape of two semicircular rods 71a, 71b when it is assembled to the semicircular rods 71a, 71b; a lower bar 73 that is fitted into the outside of the lower rod in a length direction to balance a weight center and cover the lower rod; and a lower bar cap 74 which is fitted into both ends of the lower rod 73 for the semicircular rods 71a, 71b not to be separated to one side and on which an axial rod 741 is protruded to maintain the rotation centers of the semicircular rods 71a, 71b.

According to the embodiment of a first aspect of the present invention as described above, the difficulty caused when the blind cloths are assembled to the semicircular rods 71a, 71b due to the limitation of the separation of the lower ends of the front and rear blind cloths 11, 18 from each other by the cord line 14 is mitigated, wherein two semicircular rods 71a, 71b are assembled to the front and rear blind cloths 11, 18, respectively, thereby improving convenience of assembly and production efficiency.

Further, even though the semicircular rods 71a, 71b are formed as two semicircles, the two semicircular rods 71a, 72b are arranged as one circle and assembled with the lower rod cap 72, thereby forming one lower rod having a circle shape, similar to the existing lower rod cap. The subsequent assembling process of the weight 12 may be performed identically to a related art.

Additionally, the contact faces of two semicircular rods 71a, 71b may be adhered using bonding agents (instant glue, double-sided tape and the like) so as to prevent the semicircular rods 71a, 71b from being separated from a center.

Further, the fitting protrusions 72a are protruded to face each other on each lower rod cap 72, which are fitted into the assembly holes 711a, 711b of the semicircular rods 71a, 71b, respectively, not to be retracted wherein the fitting protrusion may be shaped as a triangle, a cone and the like but it is not limited thereto.

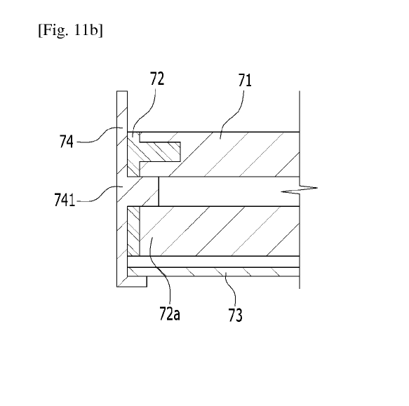

FIG. 12 is a perspective view illustrating the blind cloth that is applied to a device according to a first aspect of the present invention, wherein the front and rear blind cloths are woven as oblique line patterns, thereby creating light shielding effect of wider area and beauty effect of interior.

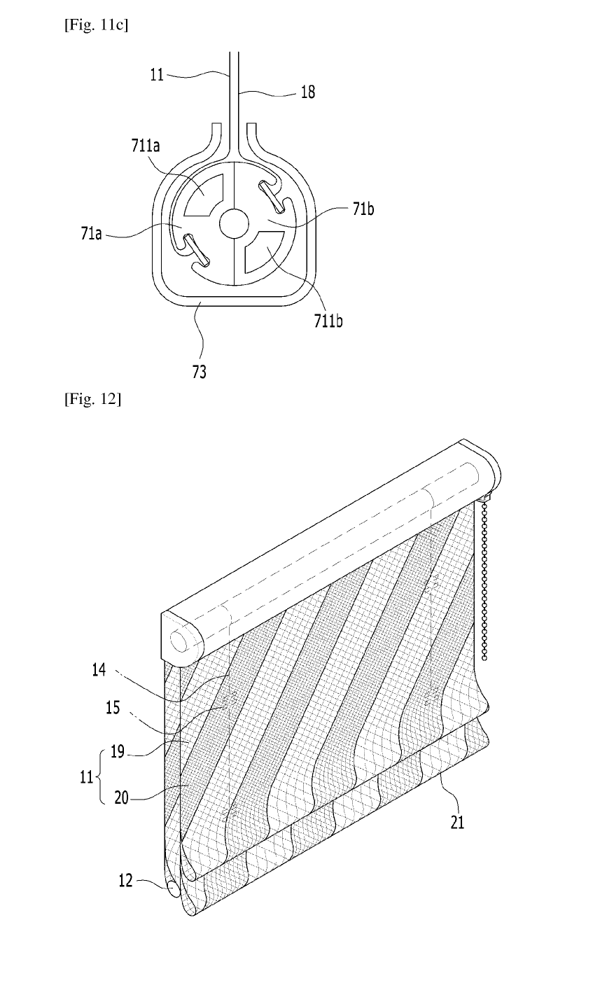

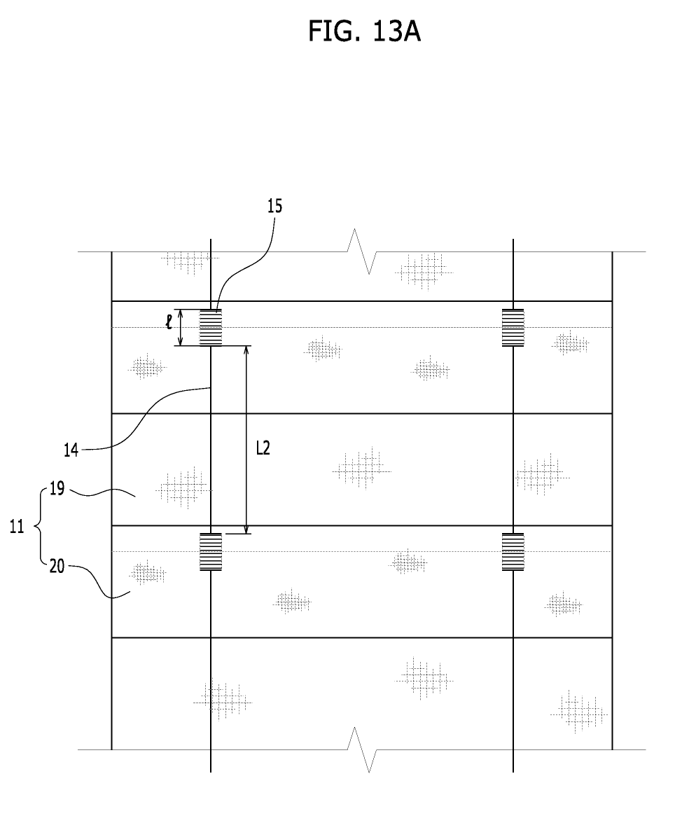

FIGS. 13a and 13b are rear views illustrating another embodiment according to a first aspect of the present invention, wherein differently from the embodiment of the present invention in which several ring sets 15 are formed within the given interval l on a back surface of the Front blind cloth 11 and the cord line 14 is passed through two or more ring sets in turn, several rings 15 are formed consecutively and the cord line 14 passed through completely the rings 15 as shown in FIG. 13a, or is unthreaded therefrom at an intermediate as shown in FIG. 13h, and thus the interval L₁ between loops and the length L₂/2 of a loop to be formed can be adjusted.

The weft with different color may be disposed on a part of the rings 15 from which the cord line is unthreaded, so as to identify easily the part of the rings from which the cord line is unthreaded while assembling the cord line 14.

Next, the operations of a Roman shade type blind cloth and a blind device using the same according to a first aspect of the present invention configured as described above will be described.

Firstly, the cord line 14 is inserted into the ring sets 15 or the interval maintaining member 16 in turn, which are formed along a vertical direction and a horizontal direction on a back surface of the front blind cloth 11 corresponding to the interval L₁ between loops and the length L₂/2 of a loop to be formed, and one end of the cord line is fixed to the weight 12 and the other end thereof is fixed to the winding-rod 13, thereby completing the assembly of the blind.

That is, similarly to the embodiment according to a first aspect of the present invention, in a case where the ring sets 15 are woven integrally on a back surface of the front blind cloth 11, the cord line 14 can be inserted into the ring sets so as to adjust the interval between loops without using any separate components. For example, when the cord line 14 is inserted into two ring sets 15 that are formed along a vertical direction of the front blind cloth, as shown in FIG. 7a, the cord line is passed through only two ring sets 15 that are adjacent up/downwardly, thereby minimizing the interval L₁ between loops.

Further, the length. L₂/2 of a loop is determined whether how long distance is left when the cord line 14 is inserted into the subsequently disposed-ring set 15 after the cord line 14 is passed through two ring sets 15.

Meanwhile, as the embodiment shown in FIGS. 8a and 8b in a case where the interval between loops is adjusted by arranging the interval maintaining member 16 on a back surface of the front blind cloth 11, the interval L₁ between loops is determined depending on the length and number of the interval maintaining member 16 that is fixed to a back surface of the front blind cloth 11.

In a state where the blind that is assembled completely (manually or automatically) is arranged on a window, when the rear blind cloth. 18 and the cord line 14 are unwound fully from the winding-rod. 13 by pulling the adjusting-line 22, as shown in FIG. 6a, the weight 12 is disposed at a bottom dead point so that the loop 21 is not formed on the front blind cloth 11, thereby maintaining a state in which the interior is shielded from outside. Under this state when the winding-rod 13 is rotated by pulling the adjusting-line 22 by a user, the cord line 14 and the rear blind cloth 18 are wound around the winding-rod. 13, and the weight 12 to which the cord line 14 and the other end of the rear blind cloth. 18 are fixed is raised, and as a result the loop 21 is formed at a point where the cord line is passed through a first ring set portion from the weight 12. Subsequently, when the cord line 14 and the rear blind cloth 18 are wound further around the winding-rod 13 by pulling continuously the adjusting-line 22, a second loop 21 is formed at a point between the ring sets portions through which the cord line is passed firstly and secondly, as shown in FIG. 6b. Here, the description of “the ring sets portions through which the cord line is passed firstly and secondly” means, for example, the ring sets 15 into which the cord line 14 is inserted on the first and second light-shielding parts 20 of the lowest end of the front blind cloth 11 consisting of the light-transmitting part 19 and the light-shielding part 20 repeatedly.

While the loop 21 is formed on the front blind cloth 11 in the way as described above, in a case of a Roman shade blind where the Light-transmitting part 19 and the light-shielding part 20 are formed consecutively on the front and rear blind cloths 11, 18, the light-transmitting parts 19 of the front and rear blind cloths 11, 18 are to be corresponded, thereby performing the brightness and ventilation of interior.

As another embodiment according to a first aspect of the present invention, even when the lower ends of the front and rear blind cloths 11, 18 are fixed to the separate weights 12a, 12b, respectively, as shown in FIGS. 10a and 10b, the above operational processes are to be identical. However, since the weights 12a, 12b are arranged separately, the rear blind cloth 18 is wound firstly in accordance with the rotation of the winding-rod 13 when it is operated and thus the weight 12b of the rear blind cloth 18 is raised until it contacts the ring set portion 15 at the lowest end of the front blind cloth 11. From the time when the weight 12b of the rear blind cloth 18 contacts the ring set portion 15 at the lowest end of the front blind cloth 11, the weight 12b pulls upwardly the ring set portion 15 at the lowest end of the front blind cloth 11 and thus the front blind cloth 11 is raised, therefore it gradually becomes a form of a loop from the lower end of the front blind cloth 11.

On the contrary, when the front and rear blind cloths 11, 18 are lowered, the loop 21 that has been formed on the front blind cloth 11 is unfolded to its original shape while the front and rear blind cloths are lowered gradually due to self-weights of the weights 12a, 12b, and the front blind cloth 11 is unfolded completely and the weight 12b of the rear blind cloth 18 is to be separated from the ring set portion 15 at the lowest end of the front blind cloth 11 while they are lowered to the lowest part. Of course, the lowering distance is limited since the lengths of the front and rear blind cloths 11, 18 and the cord line 14 are predetermined.

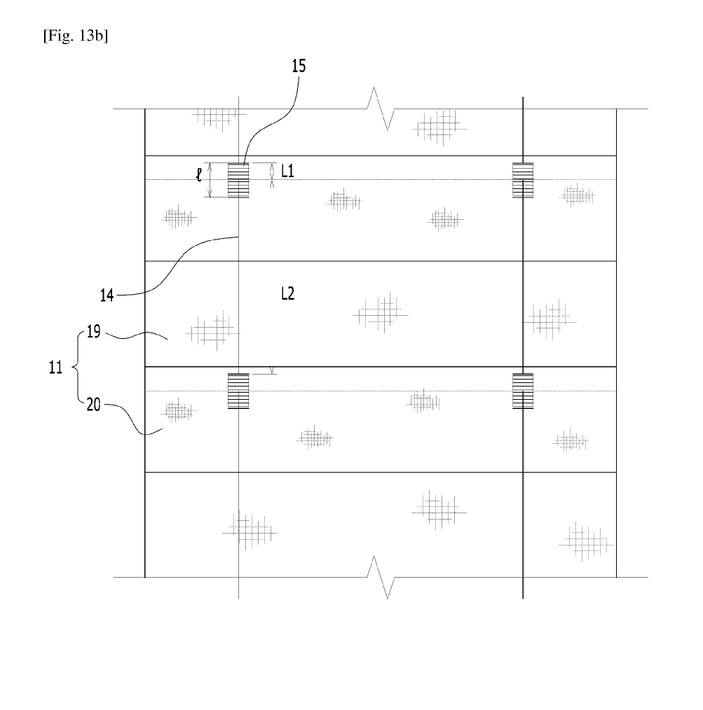

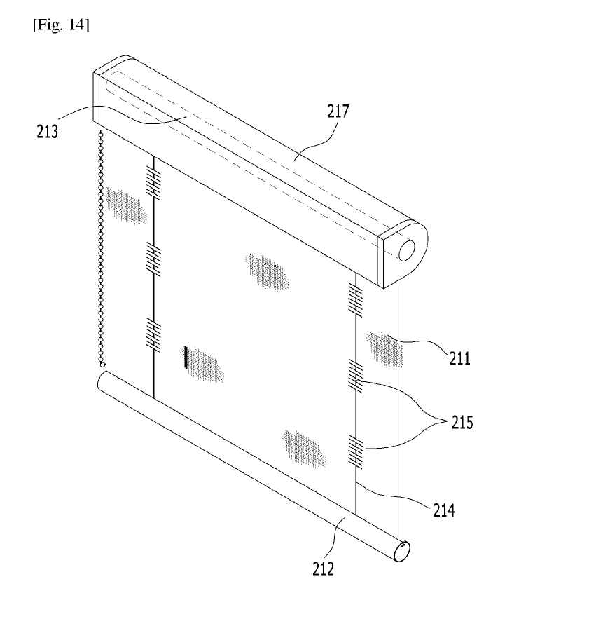

Subsequently, a Roman shade type blind cloth and a blind device using the same according to a second aspect of the present invention will be described, referring to FIGS. 14 to 20b. When describing the blind cloth and the blind device according to a second aspect of the present invention, the descriptions of the configuration and operation similar to those of the blind cloth and the blind device according to a first aspect of the present invention are omitted.

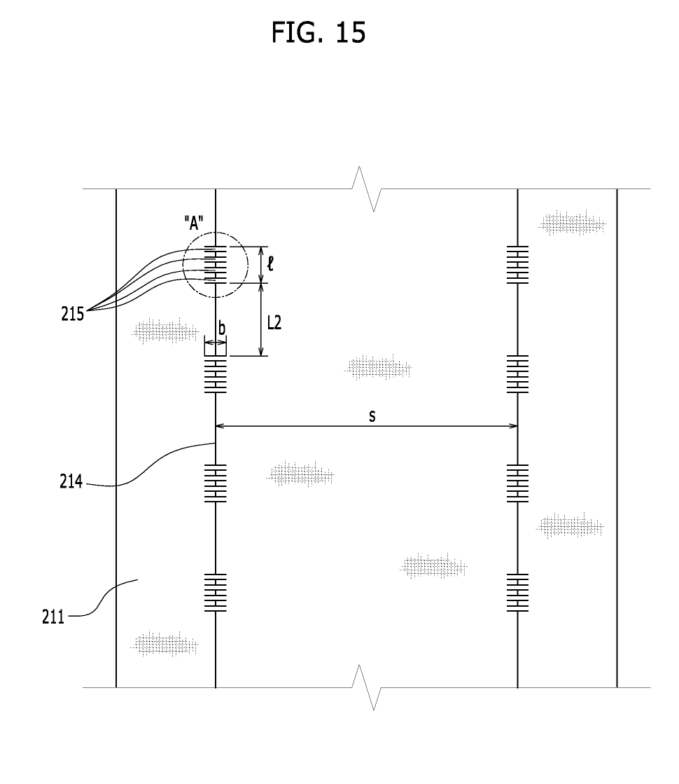

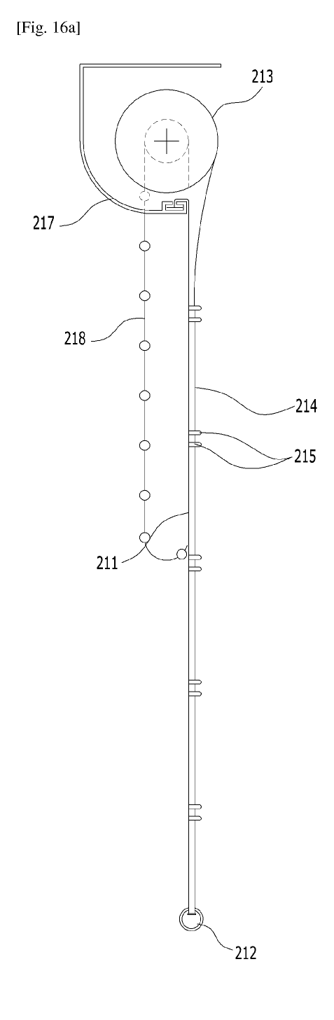

FIG. 14 a rear perspective view illustrating an embodiment according to a second aspect of the present invention, FIG. 15 is a rear view illustrating a blind cloth to which an embodiment according to a second aspect of the present invention is applied, and FIGS. 16a and 16b are longitudinal sectional views of FIG. 14.

In the embodiment according to a second aspect of the present invention one end of a blind cloth 211 is fixed to a frame 217 and the other end thereof is fixed to a weight 212, one end of a cord line 214 is fixed to the weight 212 together with the blind cloth 211 and the other end thereof is fixed to a winding-rod 213 while it passes through the ring sets that are formed at a predetermined interval on a back surface of the blind cloth 211, and a loop 219 is formed or retracted on the blind cloth 211 depending′ on whether the cord line 214 is wound or unwound around the winding-rod 213 by pulling an adjusting-line 218. These configurations are identical to those of a conventional Roman shade type blind and thus the detailed descriptions thereof are omitted.

Further, even though the ring 215 that is formed with maintaining a predetermined space “s” in a horizontal direction on a back surface of the blind cloth 211 may be woven integrally as two or more lines in a horizontal direction depending on whether a width of the blind cloth 211 in a horizontal direction is wide or narrow in each embodiment according to a second aspect of the present invention. However, hereinafter, only the ring set 215 of one line will be described.

According to another embodiment of a second aspect of the present invention, the blind cloth 211 is woven such that two or more ring sets 215 are formed repeatedly within a given interval l on a back surface thereof. Here, the description of “a blind cloth 211 is woven integrally such that two or more ring sets 215 are formed repeatedly within a given interval l on a back surface thereof” means that the weft and the warp are woven in a case of a general weaving method, however, in a case of the ring set 215 that is formed on a back surface of the blind cloth 211 in the embodiment according to a second aspect of the present invention, the weft is woven not to be entangled with the warp by floating it by a width b of the ring set 215, thereby to form the ring set 215. Further, the description means that the weft and the warp are woven to be entangled in the region where the ring set is not formed between one ring set 215 and the adjacent ring set 215. Here, whether the interval between the ring sets is woven densely or sparsely is determined depending on material of fabric, thickness of fabric and whether the fabric is coated or not, etc.

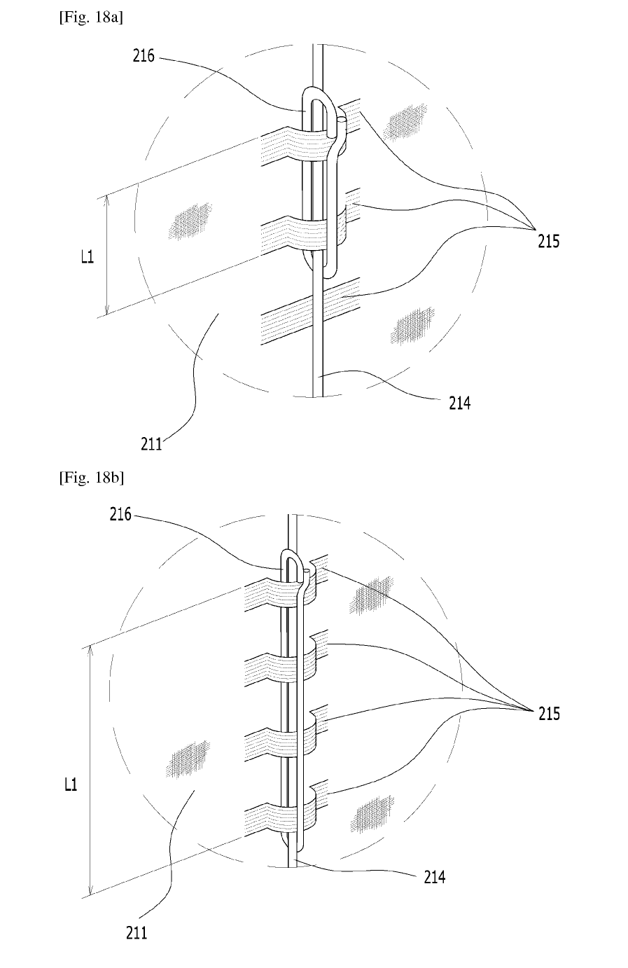

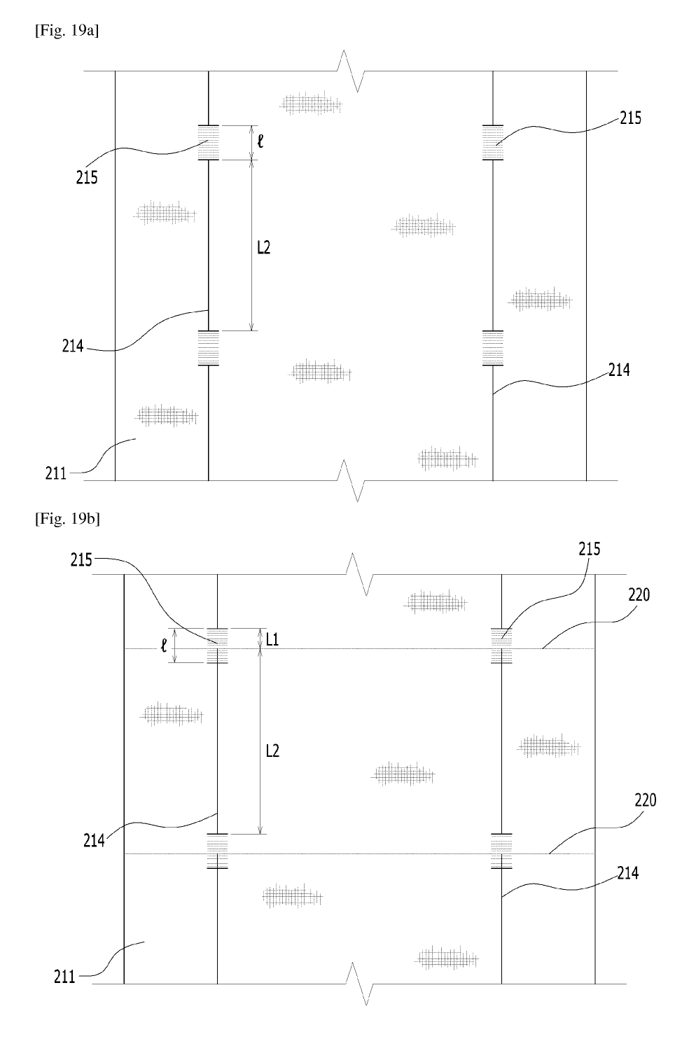

According to another embodiment of a second aspect of the present invention, the blind cloth is woven such that all of wefts within the given interval l on a back surface of the blind cloth 211 are not entangled with warp thereby to form consecutively several rings 215, and then the cord line 14 is passed through completely the rings 215 as shown in FIG. 19a, or is unthreaded at a set location (for example, at the ½ point or ⅓ point of the rings) as shown in FIG. 19b, to be assembled to adjust easily the interval L₁ between loops and the length L₂/2 of a loop to be formed. Here, the description of “the blind cloth is woven such that all of wefts within the given interval l on a back surface of the blind cloth 211 not to be entangled with warp by floating them thereby to form integrally the rings” means that the rings are formed consecutively through all intervals between the rings without any gap therebetween, and that all of wefts with the given interval l are floated by the width b of a ring not to be entangled with the warp such that the wefts become the rings. That is, it can be cleared by understanding the difference between forming two or more ring sets 15 and forming consecutively a plurality of rings within the predetermined interval l as described above.

According to another embodiment of a second aspect of the present invention, the wefts are woven not to be tangled with warp by the width b of a ring so that the rings 215 are formed consecutively up/downwardly on a back surface of light-shielding blind cloth 211 and then the cord line 214 is unthreaded at equal-intervals from random locations of the rings as shown in FIG. 20a, or is unthreaded at gradually increasing intervals downwardly as shown in FIG. 20b thereby to adjust easily the interval L₁ between loops and the length L₂/2 of a loop. Here, the description of “all of wefts at a region where the rings 215 are formed on a back surface of light-shielding blind cloth 211 are woven not to be tangled with warp by floating them by the width b of a ring” means that the rings are formed consecutively through all back surface of the blind cloth 211 as shown in FIG. 20a.

In each embodiment as shown in FIGS. 19a to 20b the weft 220 with different color may be disposed at predetermined portions of the rings 215, from which the cord line 214 is unthreaded, so as to identify easily the part of the rings from which the cord line is unthreaded while assembling the cord line 214.

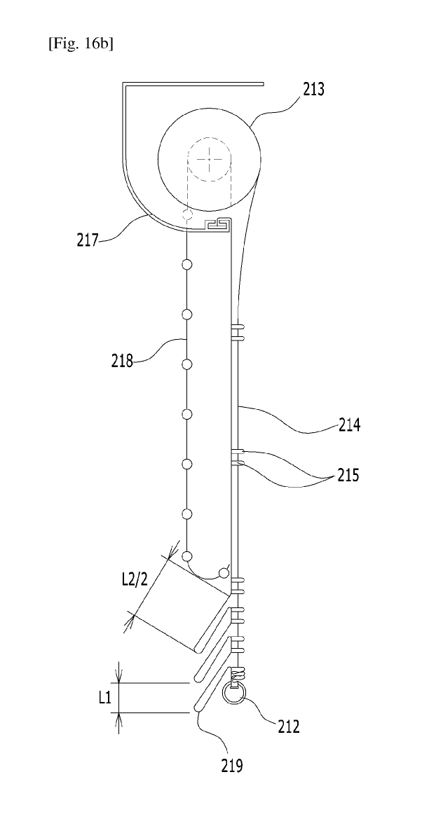

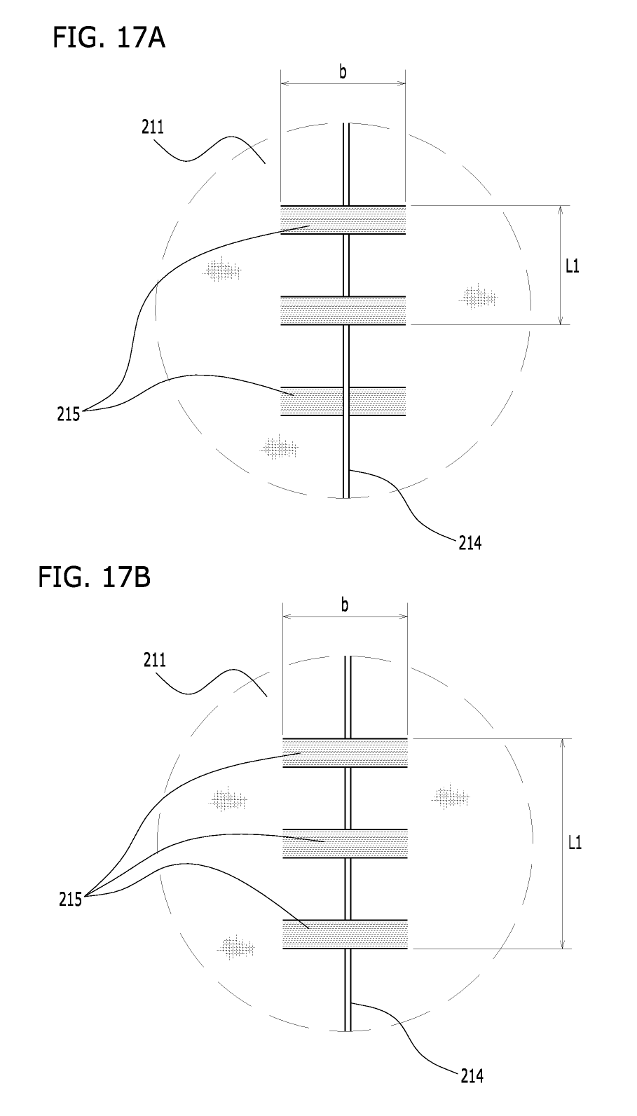

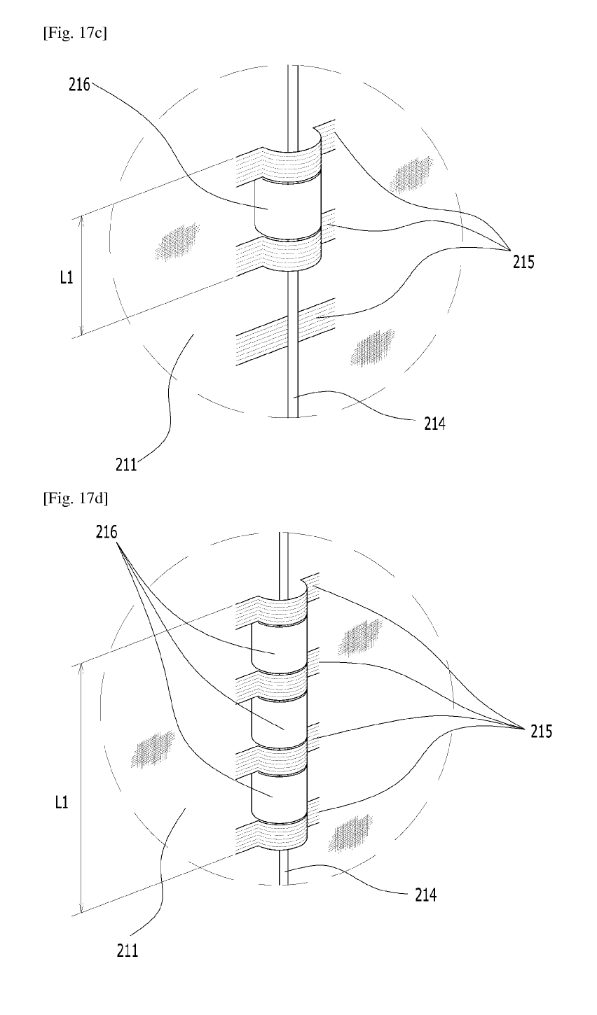

FIG. 17a is a detailed view illustrating a first embodiment of “A” part of FIG. 15, wherein two rimy sets 215 through which the cord line 214 passes are formed on a back surface of the blind cloth 211 and the cord line 214 is passed through the two ring sets 215 in turn thereby to determine the interval L₁ between loops. That is, when the cord line 214 is inserted into each ring set 215 that is formed along a vertical direction of the blind cloth 211, the cord line 214 is passed through only two adjacent ring sets 215 when forming the interval L₁ between loops to be narrow as shown in FIG. 17a. On the other hand, the cord line 214 is passed through adjacent three or more ring sets 215 when forming the interval L₁ between loops to be wide as shown in FIG. 17b, thereby adjusting easily the interval L₁ between loops when assembling the blind.

FIG. 17c is a detailed view illustrating a third embodiment of “A” part of FIG. 15, wherein an interval maintaining member 216 is fitted between the ring sets 215 on a back surface of the blind cloth 211, such that the cord line 214 is passed through one ring set 215, the interval maintaining member 216 and another ring set 215 in turn to determine the interval L₁ between loops.

FIG. 17d is a detailed view illustrating a fourth embodiment of “A” part of FIG. 15, wherein a plurality of interval maintaining members 216 are arranged between four ring sets 215, respectively, when forming the interval L₁ between loops to be wider such that the cord line 214 is passed through one ring set 215, the interval maintaining members 216 and other ring sets 215 in turn.

FIGS. 18a and 18b are views illustrating a fifth and sixth embodiments of “A” part of FIG. 15, wherein the interval maintaining member 216 may be formed as a long ring pin-type one side of which is opened such that the ring set 215 is fitted and retracted therethrough, and the size of which is determined such that the interval maintaining member is fitted into two ring sets 215 as shown in FIG. 18a, or it is fitted into simultaneously four ring sets 215 as shown in FIG. 18b, by using a bend-molding or injection-molding method. At this time, the cord line 14 is passed through the interval maintaining member 216 of a ring pin type which is fitted into the ring sets 215, thereby connecting simply between the ring sets.

The set interval l and the interval L₁ between loops have the same meaning in the embodiments according a second aspect of the present invention.

Subsequently, the operations of a blind device configured according to a second aspect of the present invention will be described.

Firstly, the upper and lower ends of light-shielding blind cloth 211 are fixed to a frame 217 and a weight 212, respectively, and the cord line 214 is inserted into the rings 215 or the interval maintaining member 216 in turn that are formed along a vertical direction and a horizontal direction on a back surface of the blind cloth 211 corresponding to the interval L₁ between loops and the length L₂/2 of a loop to be formed, and then one end of the cord line 214 is fixed to the weight 212 together with the blind cloth. 211 and the other end thereof is fixed to a winding-rod 213 while the blind is assembled, thereby completing an assembly of the blind.

When assembling a blind, the length L₂/2 of a loop is determined whether how long distance is left when the cord line 214 is fitted into the subsequently disposed-ring set 215 after the cord line 214 is passed through two ring sets 215.

In a state where the blind that is assembled completely (manually or automatically) is arranged on a window, when the cord line 214 are unwound fully from the winding-rod 213 by pulling the adjusting-line 218, as shown in FIG. 16a, the weight 212 is disposed at a bottom dead point so that the loop 219 is not formed on the front blind cloth 211, thereby maintaining a state in which the interior is shielded from outside.

Under this state when the winding-rod 213 is rotated by pulling the adjusting-line 213 by a user, the cord line 214 is wound around the winding-rod 213, and the weigh part 212 to which the cord line 214 and the other end of the rear blind cloth 211 are fixed is raised, and as a result the loop 219 is formed at a point where the cord line is passed through a first ring sets portion. 215 from the weight 212.

Subsequently, when the cord line 214 is wound further around the winding-rod 213 by pulling continuously the adjusting-line 218, a second loop 221 and a third loop 221 are formed between the ring sets portions through which the cord line are passed firstly, secondly and thirdly, respectively, as shown in FIG. 16b.

Meanwhile, in FIG. 19a showing another embodiment according to a second aspect of the present invention only when the cord line 14 is passed through the rings 15 that are formed on a back surface of the blind cloth 11 in turn and the one end of the cord line is fixed to the weight 12 together with the blind cloth 11 and the other end thereof is fixed to the winding-rod 13, the assembly of the blind is completed.

Further, in cases of FIG. 19b and FIG. 20a showing another embodiment only when the cord line 214 is passed to be fitted into the set locations of the rings 215 that are formed on a back surface of the blind cloth 211, or as shown in FIG. 20b, the cord line 214 is inserted into the rings 215 such that the length L₂/2 of a loop is increased gradually downwardly, and then one end of the cord line is fixed to the weight 212 together with the blind cloth 211 and the other end thereof is fixed to the winding-rod 213, the assembly of the blind is completed wherein the operations thereof are identical to those of the first embodiment and thus detailed descriptions thereof are omitted.

Here, it is cleared that the winding-rod 213 may be replaced with a rotation shaft and bobbin.

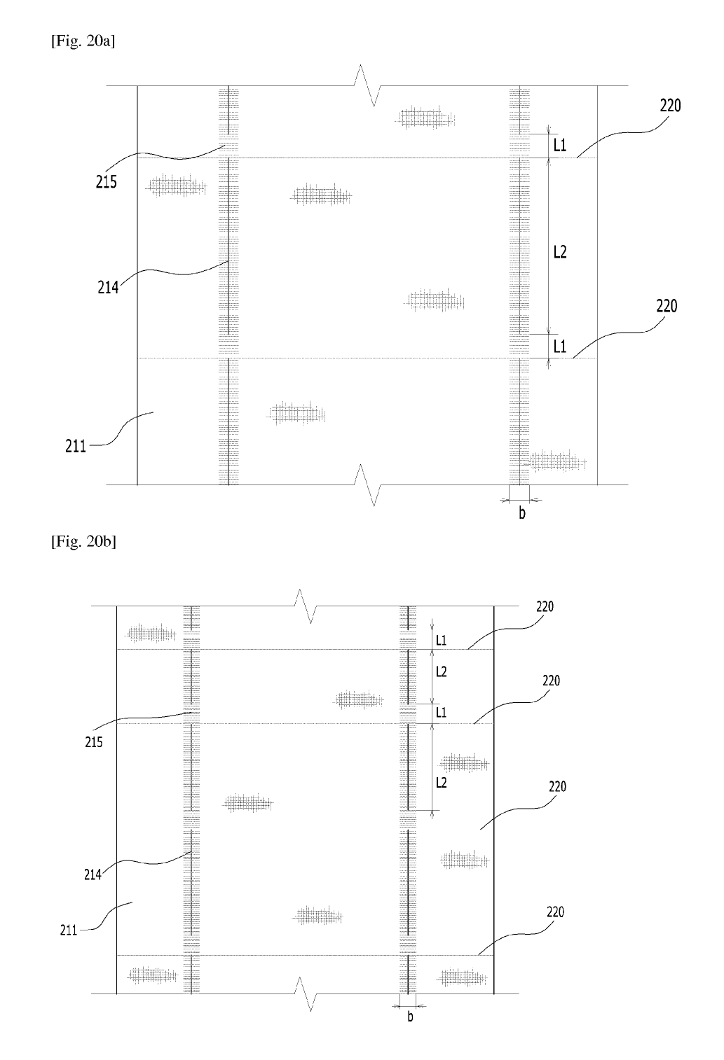

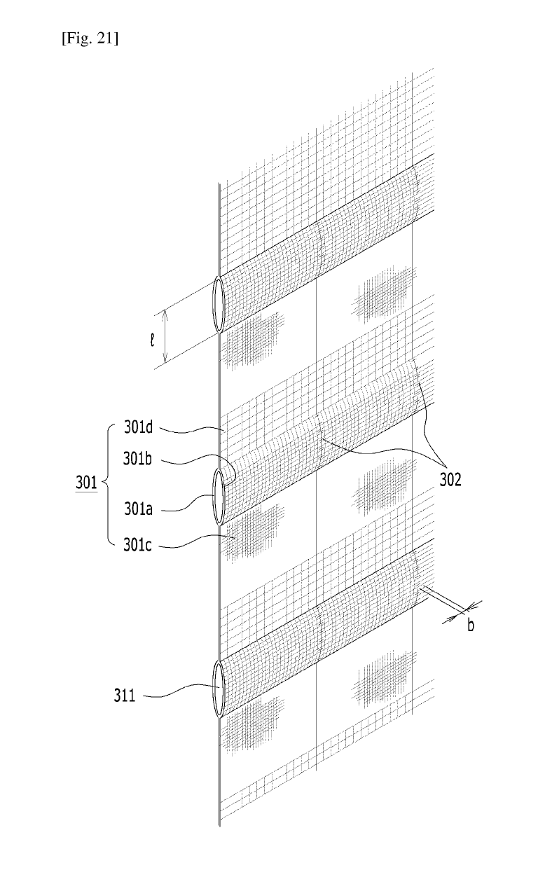

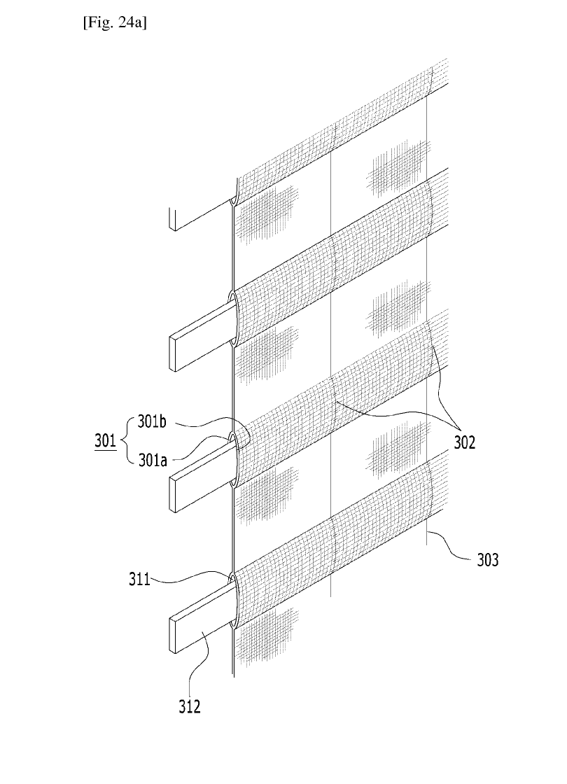

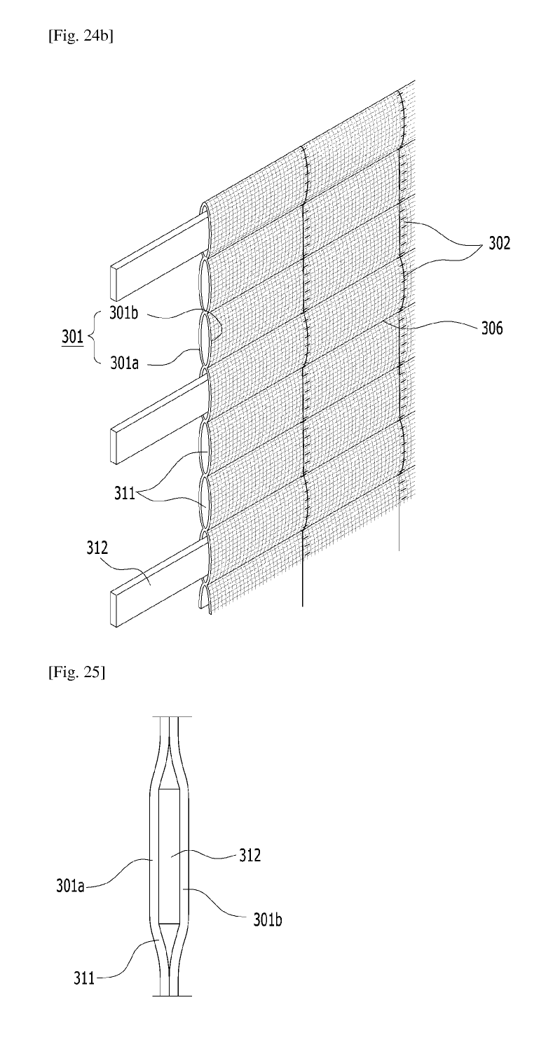

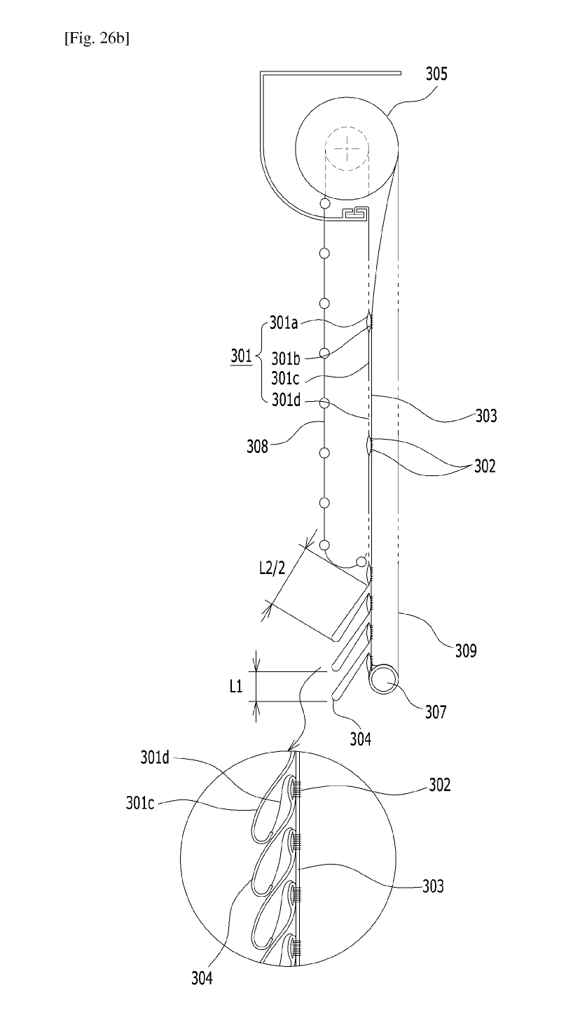

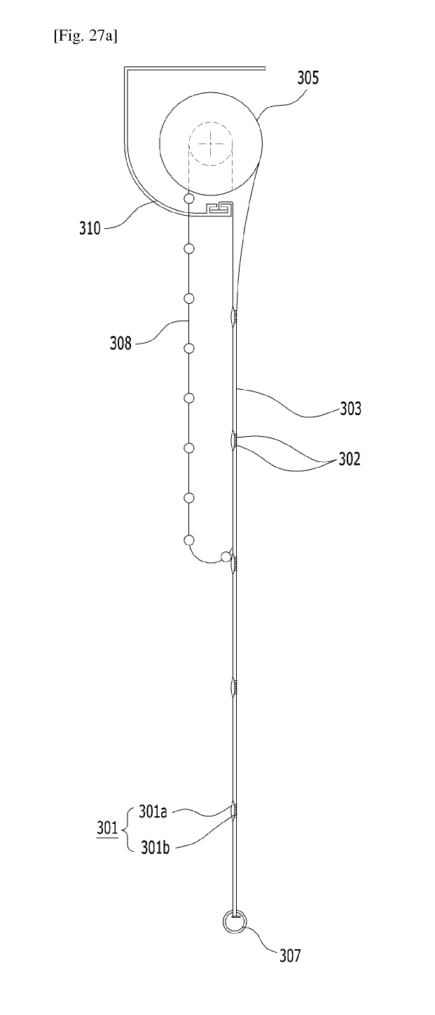

Next, a Roman shade type blind cloth and a blind device using the same according to a third aspect of the present invention will be described, referring to FIGS. 21 to 27b. When describing the blind cloth and blind device according to a third aspect of the present invention, the descriptions of the configurations and operations similar to those of the blind cloths and blind devices according to a first and second aspect are omitted.

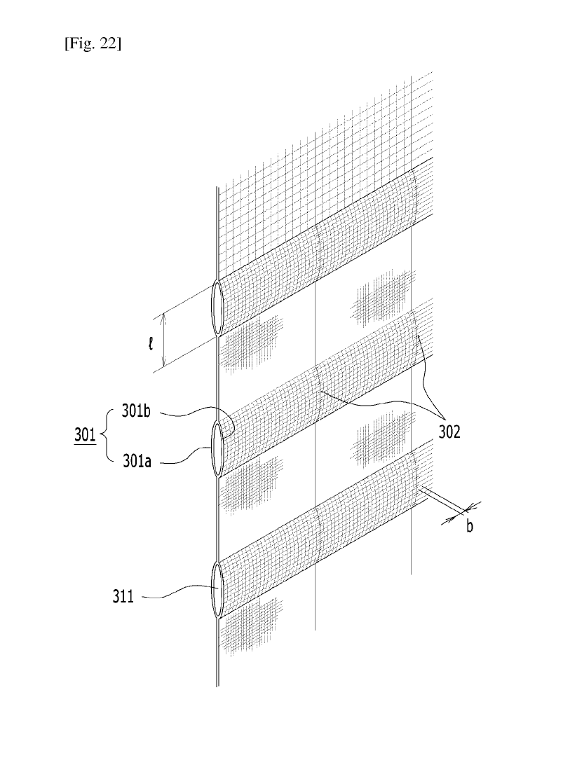

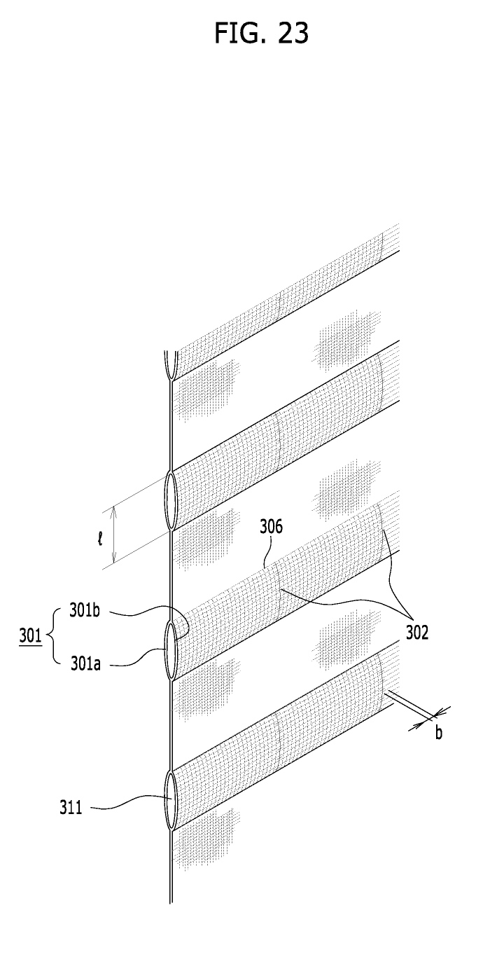

The blind cloth according to a third aspect of the present invention is woven such that the wefts are not entangled with the warps by a width b of a ring so that the ring 302 is formed on a back surface of the blind cloth 301 wherein it is woven to be provided with internal and external fabrics 301a, 301b of double layers so that a pocket 311 is formed through the blind cloth 301, and the ring 302 is formed on the external fabric 301b that is disposed toward a window. At this time, a light-transmitting part 301c and a light-shielding part 301d are formed consecutively and repeatedly on the blind cloth as shown in FIG. 21, or only the light-transmitting parts or the light-shielding parts are arranged thereon as shown in FIGS. 22 and 23.

In a case of the blind cloth 301 consisting of the light-transmitting part 301c and the light-shielding part 301d, it is woven as the internal and external fabrics 301a, 301b of double, layers so that the pocket 311 is formed on an upper-part of the light-shielding part 301c wherein it is woven such that one or more rings 302 are formed repeatedly within a given interval l of the external fabric 301b.

Further, in a case of the blind cloth 301 consisting of only the light-transmitting parts or the light-shielding parts, as shown in FIG. 22, it is woven as the internal and external fabrics 301a, 301b of double layers that are formed repeatedly, leaving a given interval, so that the pockets 311 are formed wherein it is woven such that one or more ring sets are formed repeatedly within a given interval l of the external fabric 301b.

Additionally, as shown in FIG. 23, in the blind cloth 301 the internal and external fabrics 301a, 301b are woven consecutively so that the pockets 311 are formed consecutively by a boundary portion. 306, wherein it is woven such that one or more rings 302 are formed repeatedly within a given interval l of the external fabric 301b.

The blind cloth according to a third aspect is different from those of a first and second aspects of the present invention in respect that the blind cloth 301 at a part of which the ring 302 is formed is woven as double layers of the internal fabric 301a that is disposed at interior and the external fabric 301b that is disposed toward a window.

Further, while a part of the blind cloth according to a third aspect of the present invention on which the ring 302 is formed is woven as double layers, it is woven such that all of wefts at a ring portion of the external fabric 301b of a window are not entangled with warp by a width b of a ring so that the ring 302 is formed. At this time, the external fabric is woven such that one or more rings 302 are formed repeatedly within a given interval l.

In the blind cloth according to a third aspect of the present invention when the loop 304 is formed on the blind cloth 301 as the cord line 303 that is inserted into the ring 302 is wound around a winding-rod (not shown), even though the ring portion formed on the external fabric 301h of a window is deformed, the deformed part is covered with the internal fabric 301a of a window not to be exposed outside.

As in FIG. 21 showing the blind cloth 301 that is applied to a third aspect of the present invention as an embodiment, the blind cloth may be woven such that the light-transmitting part 301d and the light-shielding part 301c are formed consecutively and repeatedly. However, as in FIGS. 22 and 23 showing another embodiment, the blind cloth 301 may be woven only with the light-shielding part.

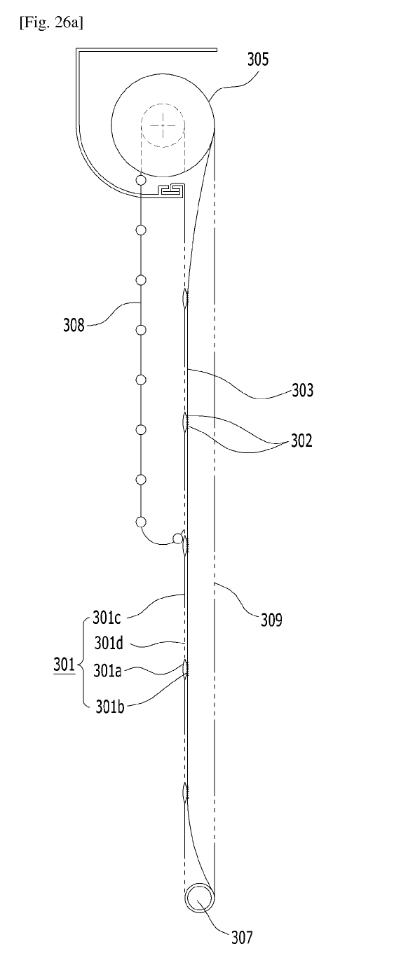

The blind cloth 301 of FIGS. 26a and 26b showing an embodiment according to a third aspect of the present invention is provided with a front blind cloth 303 and a rear blind cloth 309. And the interior can be bright and well-ventilated by corresponding the light-transmitting parts thereof even without winding the rear blind cloth 309 around the winding-rod 305. At this time, the rear blind cloth 309 is identical to the front blind cloth 303 according to a third aspect of the present invention, or may be a blind cloth only consisting of a light-transmitting part and a light-shielding part or any blind cloth.

FIG. 24b is a perspective view illustrating another embodiment of a blind cloth according to a third aspect of the present invention, wherein while the blind cloth 301 is woven consecutively as double layers such that a boundary portion. 306 is disposed at a predetermined interval, it is woven such that all of wefts at a ring portion of the external fabric 301b are not to be entangled with warp by floating them at a predetermined interval, the rings 302 are formed consecutively up/downwardly.

In each embodiment according to a third aspect of the present invention, the internal fabric 301a and the external fabric 301b are shown to be spaced each other to be identified with naked eyes, however it can be understood that they contact each other when weaving them.

The blind cloth and the blind device according to a third aspect of the present invention is provided with the internal fabric 301a and the external fabric 301b such that the pocket 311 is formed through the front blind cloth 301. Further, it is woven such that one or more rings 302 are formed within a given interval of the external fabric 301b, and then the cord line 303 is passed through the rings in turn thereby to adjust the interval L₁ between loops and the length L₂/2 of a loop to be formed.

In the blind of each embodiment according to a third aspect of the present invention the pockets 311 of the front blind cloth 301 are arranged to be repeated with leaving a given interval; or the front blind cloth 301 is provided with the internal and external fabrics 301a, 301b consecutively arranged such that the pockets 311 are formed consecutively by the boundary portion 306; or as shown in FIGS. 24a and 24b tension bands 312 are fitted into the pockets 311 at set locations of the front blind cloth 301 to maintain the tension states of the internal and external fabrics 301a, 301b, which will be chosen freely.

Next, the operations of the blind device configured according to a third aspect of the present invention will be described.

Firstly, as shown in FIGS. 26a and 26b, the cord line 303 is inserted into the rings 302 in turn that are formed along a vertical direction and a horizontal direction on a back surface of the blind cloth 301 corresponding to the interval L₁ between loops and the length L₂/2 of a loop to be formed while a blind is assembled, and then one end of the cord line is fixed to the weight 307 together with the front and rear blind cloths 301, 309 and the other end thereof is fixed to the winding-rod 305 together with the upper end of the rear blind cloth 309, thereby completing an assembly of the blind.

That is, in FIGS. 21 and 22 showing one embodiment and another embodiment according to a third aspect of the present invention, the length L₂/2 of a loop is determined whether how long distance is left when the cord line 303 is inserted into the subsequently disposed-ring 302 after the cord line 303 is inserted into two or more rings 302 that are formed along a vertical direction of the external fabric 301b of the blind cloth 301, which is disposed toward a window.

In a state where the blind that is assembled completely (manually or automatically) is arranged on a window, when the cord line 303 is unwound fully from the winding-rod 305 by pulling the adjusting-line 308, as shown in FIG. 26a, the weight 307 is disposed at a bottom dead point so that the loop 304 is not formed on the blind cloth 301, thereby maintaining a state in which the interior is shielded from exterior.

Under this state when the winding-rod 305 is rotated by pulling the adjusting-line 308 by a user, the cord line 303 and the rear blind cloth 309 are wound around the winding-rod 305, and the weight 307 to which the cord line 303 and the other ends of the blind cloths 301, 309 are fixed is raised, and, as a result, the loop 304 is formed at a point where the cord line is passed through a first ring portion 302 from the weight 307.

Subsequently, when the cord Line 303 and the rear blind cloth 309 are wound further around the winding-rod 305 by pulling continuously the adjusting-line 308, a second loop and a third loop 304 are formed between the ring portions through which the cord line 303 is passed firstly and secondly, as shown in FIG. 26b.

Here, “the ring portions through which the cord line is passed through firstly and secondly” means, for example, the ring portions 302 which are formed firstly and secondly on the lowest end of the blind cloth 301 and into which die cord line 303 is inserted.

While the loop 304 is formed by the ring sets 302 formed on the external fabric 301b of a window by pulling the adjusting-line 308, the texture is not dense since the weft serving as the ring is not entangled with warp and further the ring portion is bulged frontward due to the deformation of the ring 302. However, in the blind cloth and the blind device using the same according to a third aspect of the present invention, the internal fabric 301a is disposed in front of the external fabric 301b of a window on which the ring 302 is formed, thereby covering the bulged portion and always maintaining an even state of the blind cloth 301 which is shown from interior.

Further, the tension band 312 may be fitted into the pocket 311 at a set location of the front blind cloth 301 thereby to maintain tension states of the internal and external fabrics 301a, 301b, thereby preventing deformations thereof in advance.

The tension band 312 may be thin relatively and, if necessary, may be made of synthetic resin, wood, light, metal or the like.

Further, a rotation shaft and a bobbin (not shown) may be provided separately in addition to the winding-rod 305 and the cord line 303 may be wound around the bobbin when the rotating shaft rotates.

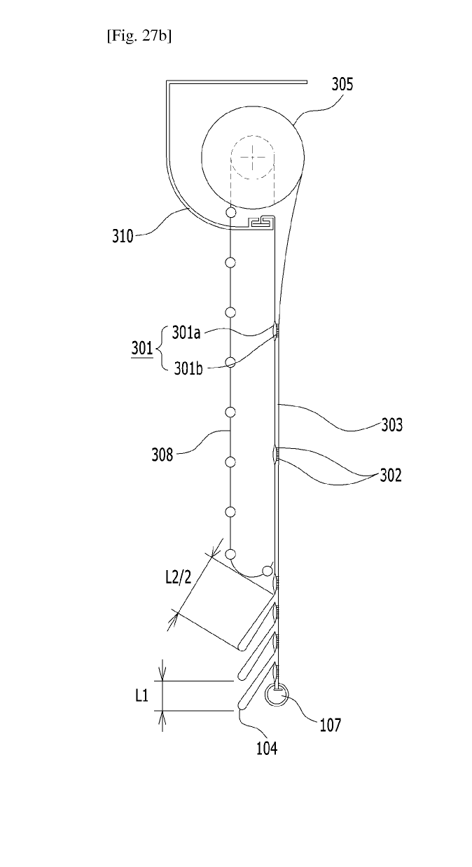

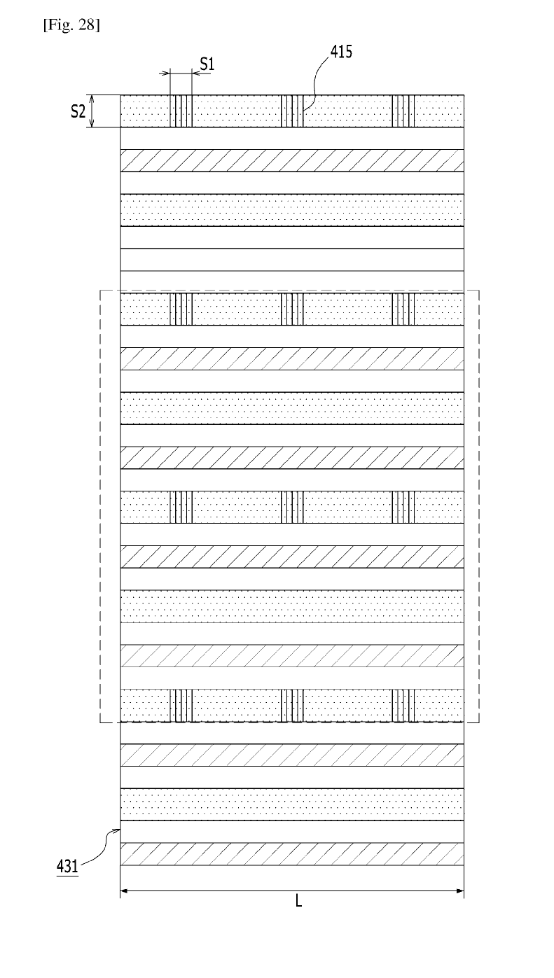

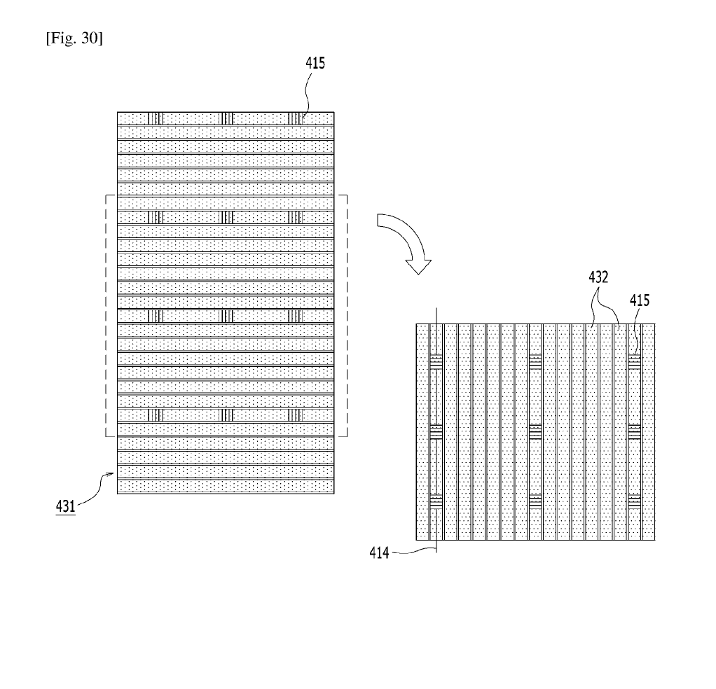

Next, a Roman shade type blind cloth according to a fourth aspect of the present invention will be described, referring to FIGS. 28 to 32. When describing the blind cloth according to the fourth aspect, the descriptions of the configurations and operations similar to those of the blind cloth according to a first to third aspects of the present invention are omitted.

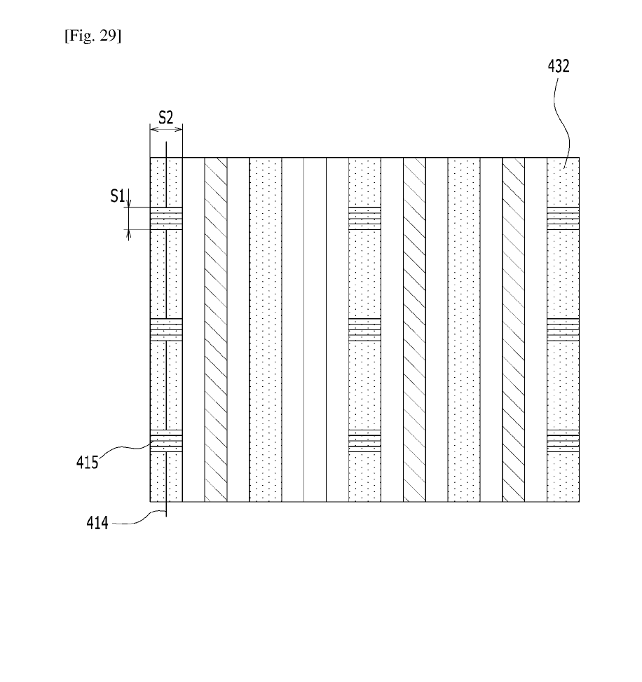

FIG. 28 is a rear view illustrating an embodiment of a Roman shade type blind cloth according to a fourth aspect of the present invention. FIG. 29 is a view illustrating a state where the blind cloth of FIG. 28 is cut depending on a width of a window to be rotated at 90°.

As shown in FIG. 28, when the Roman shade type blind cloth 431 according to a fourth aspect of the present invention is woven, it is woven such that warps are floated not to be entangled with wefts at a predetermined region, into which a cord line 414 is inserted, to form the ring set 415.

At this time, the warps where the ring set 415 is formed may preferably be LM (Low Melting) yarns or LM mixed yarns such that the warps are not unthreaded when the blind cloth 431 is folded or unfolded in a state where the cord line 414 is inserted into the ring 415.

A prompt operation is possible by coloring the warps with a predetermined color when the warp with a predetermined color is fitted into a heald eye without confirming the colors. Further, a phenomenon where the warps with different colors are mis-fitted inadvertently into the heald eye, like a related art, can be prevented in advance.

The blind cloth 431 according to a fourth aspect of the present invention, which is woven as described above, is implemented as various forms by coloring the wefts with different colors at desired regions and displaying different designs therefrom.

When the ring sets 415 are woven while the blind cloth 431 is woven, if a step of supplying the cord line 414 as weft and fitting the cord line 414 into the ring sets 415 is further performed, the operation of fitting separately the cord line 414 into the ring sets 415 may be deleted preferably when end product of the Roman shade type blind cloth is produced.

Further, when the Roman shade type blind cloth according′ to a fourth aspect of the present invention is woven, a step of hanging the warps with a predetermined color over a beam of a weaving machine (not shown) and fitting the warps strand by strand into the heald eye, and a step of passing the weft between the warps that are divided into two or more groups and separated and striking with a body to weave the blind cloth 531 are performed in turn, which are identical to a conventional weaving method of the blind cloth.

However, when the blind cloth 531 according to a fourth aspect of the present invention is woven, it is featured that several strands of warp are floated not to be entangled with weft at predetermined regions S1, S2 into which the cord line 414 is inserted such that the rings 415 of several strands are formed.

That is, the rings 415 of several strands are formed within a predetermined region S1 so that the loops are formed vertically on the blind cloth 431 by the region S1.

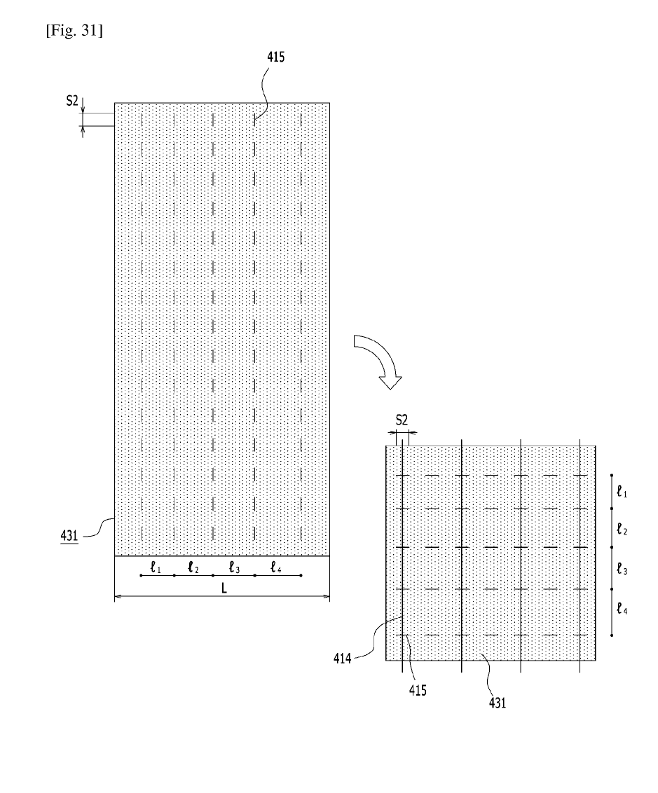

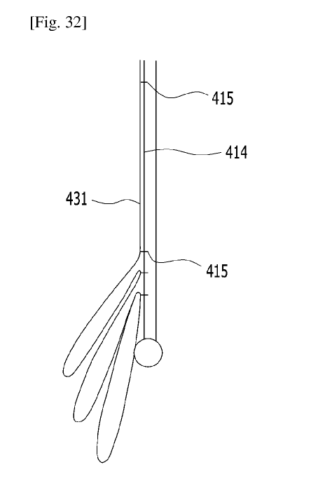

In another embodiment as shown in FIG. 31, in the step of hanging the warps over the beam of a weaving machine in turn, the warps are hung such that distance between the warps is increased gradually l₁<l₂<l₃<l₄ . . . so that the rings 415 are formed. At this time, the warp of a strand is floated not to be entangled with weft at a predetermined point into which the cord line is inserted so that the ring 415 of a strand is formed. As shown in FIG. 32, in the case of the rings 415 of warp of a strand the distance between warps are increased, gradually l₁<l₂<l₃<l₄ . . . , for example, the ring 415 of the farthest l₄ is raised and then the rings of distances l₃→l₂→l₁ are raised in order when the blind cloth 431 is raised such that the loops are formed naturally on the blind cloth 431.

Assuming that the ring is formed with constant distance between warps, the loops cannot be formed naturally vertically and the loops may be formed as a bunch of grapes. However, this phenomenon can be prevented by using the blind cloth according to the embodiment of FIG. 31.

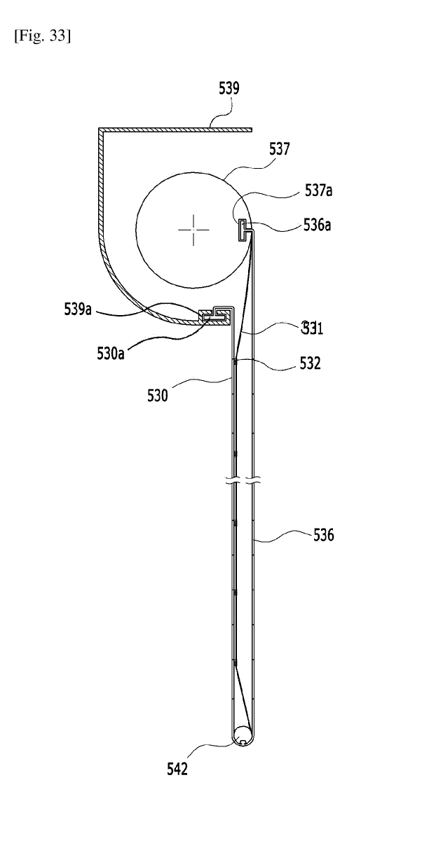

Next, a device for adjusting the length of a cord line of a Roman shade type blind cloth according a fifth aspect of the present invention will be described, referring to FIGS. 33 to 40. When describing the device for adjusting the length of a cord line of a Roman shade type blind cloth according a fifth aspect and fixing the same, the description of the configurations and operations similar to those of the blind cloth and blind device according to a first to fourth aspects as described above are omitted.

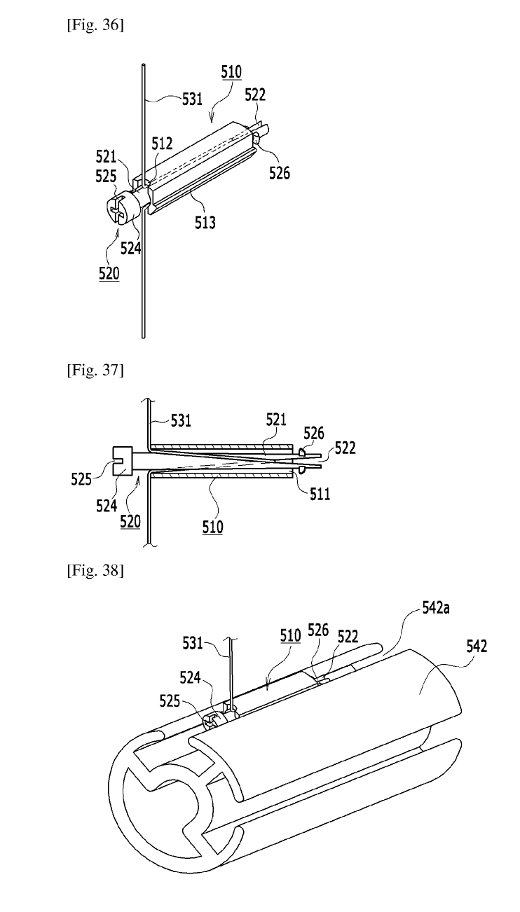

FIG. 35 is an exploded-perspective view illustrating main components of a device according to a fifth aspect of the present invention, FIG. 36 is a perspective view illustrating an assembly state of FIG. 35 and FIG. 37 is a longitudinal sectional view of FIG. 36.

It is featured that an insertion hole 511 is formed horizontally at a center of a housing 510 to which a winding-rod 537 or a weight 542 of a device according to a fifth aspect of the present invention is fixed, a taper portion 521 is formed on an adjusting-rod 520 that is inserted into the insertion hole 511 formed on the housing 510, and a supporting means for supporting a cord line 531 is formed on the adjusting-rod 520 such that the taper portion 521 is pushed forcibly into the insertion hole 511 while the cord line 531 is inserted into the supporting means of the adjusting-rod 520 to fix the cord line 531, or the length of the cord line 531 is adjusted by rotating the adjusting-rod 520.

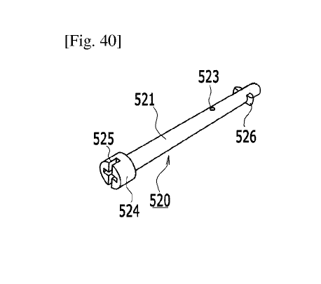

The supporting means is provided as a cutaway portion 522 which is formed at a front end of the taper portion 521 and into which the cord line 531 is inserted as in FIGS. 35 to 38 showing an embodiment according to a fifth aspect of the present invention. The support means may also be provided as a fitting hole 523 which is formed on the taper portion 521 and through which the cord line 531 passes as in FIG. 40 showing another embodiment or a fitting annular groove (not shown) that is formed on the taper portion 521.

Further, when a head portion 524 is formed on the adjusting-rod 520 and a groove for a cool 525 is formed on the head portion 524, the length of the cord line 531 can be adjusted conveniently using the tool such as a driver.

Additionally, when a catching part 526 is further formed on the cutaway portion 522, the adjusting-rod 520 can be prevented from being separated from the housing 510 while the adjusting-rod 520 is assembled preliminary to the housing 510.

Meanwhile, when a position determining groove 512 is formed as “−” or “+” shape for determining the location of the cord line 531 at an inlet of the insertion hole 511 formed on the housing 510, the cord line 531 can be inserted more quickly. When the cord line, 531 is departed from the position determining groove 512, it is difficult to adjust the length of the cord line and further the cord line 531 is departed from the housing 510 not to determine the position of the cord line 531. Therefore, the position determining groove serves as a very important factor when adjusting the length of the cord line 531.

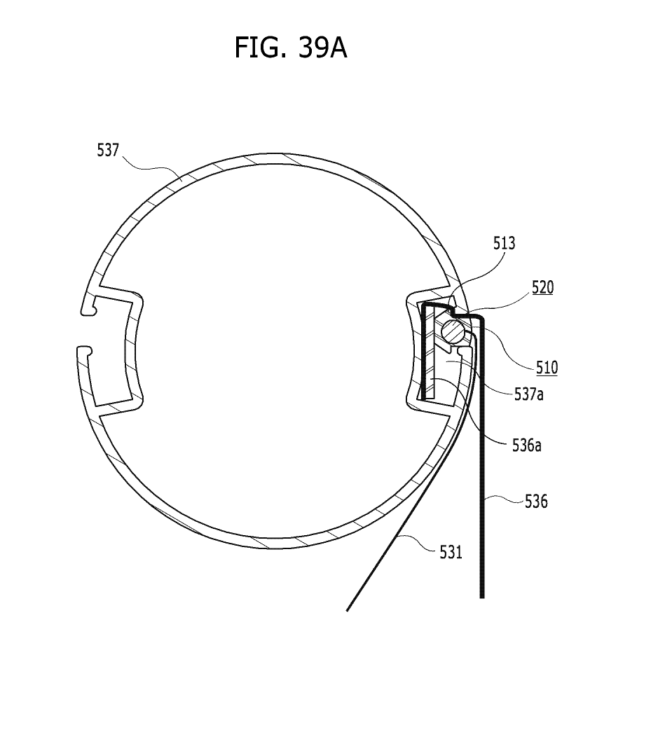

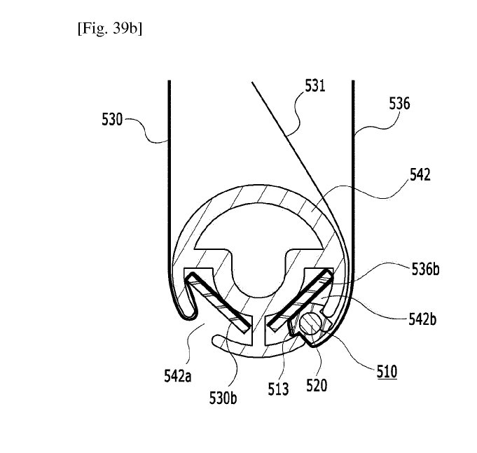

In case a hook 513 is formed on an outer circumferential surface of the housing 510 and the hook 513 is caught over mounting grooves 537a, 542b formed on the winding-rod 537 or the weight 542 and fixed thereto as shown in FIGS. 39a and 39h, the device according to a fifth aspect of the present invention can be installed more promptly. At this time, the housing 510 is made of synthetic resin having a little elasticity and thus it is contracted or recovered elastically when the housing is fitted into the mounting grooves 537a, 542b. The housing is supported firmly with the hook 513 not to be separated as long as external force does not apply thereto.

The operations of the device according to a fifth aspect of the present invention configured as described above will be described.

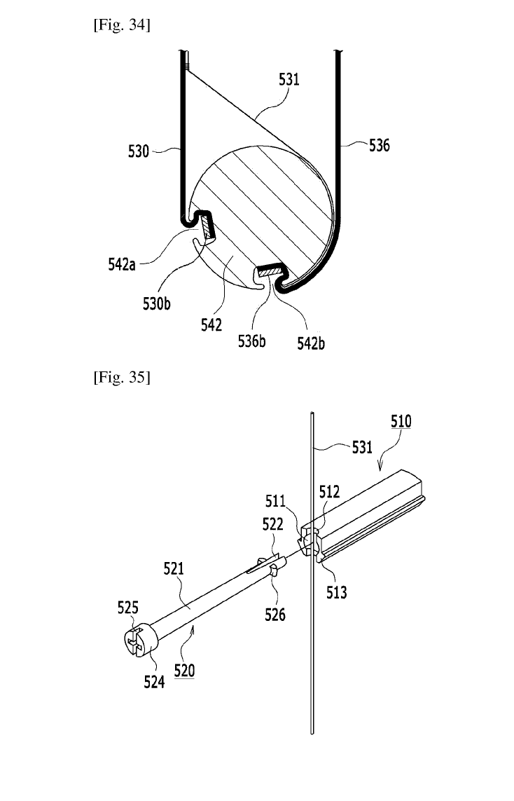

As shown in FIGS. 33 and 34, an upper end of a roll-up fabric is fixed to a winding-rod and the lower end thereof is fixed to the weight in a Roman shade type blind.

Firstly, moulds 530a, 530b, 536a, 536b are fixed to both upper and lower ends of each of a loop forming fabric 530 and a roll-up fabric 536, respectively, and they are fitted into the mounting grooves 539a, 537a, 542a, 542b that are formed on the frame 539, the winding-rod 537 and the weight 542, respectively. These operations are identical to those of a related art, and thus the detailed descriptions thereof are omitted. However, it is cleared that the order of assembly is different from that of a related art and thus it needs to understand the device according to a fifth aspect of the present invention.

Accordingly, before the upper and lower ends of the loop forming fabric 530 are fitted into the frame 539 and the weight 542, firstly the cord line 531 is inserted into the ring 532 of the loop forming fabric 530 wherein left and right intervals and the number of the cord line 531 are set corresponding to a width of the loop forming fabric 530, and the upper and lower ends of each cord line 531 are cut to be longer than a length of the loop forming fabric 530 thereby to be exposed.

Further, referring to FIG. 39a, in case the mould on the upper end 536a of the roll-up fabric 536 is fitted into the mounting groove 537a of the winding-rod 537 and fixed thereto and the housing 510 is pushed forcibly into the mounting groove 537a corresponding to the left and right intervals and the number of the cord line 531, the hook 513 of the housing 510 is caught over the mounting groove 537a and fixed thereto. At this time, the mould at an upper end 536a of the roll-up fabric 536 is supported by the assembly of the housing 510, thereby maintaining a secure assembly state thereof.

After that, the mould 530a at an upper end of the loop forming fabric 530 is fitted into the mounting groove 539a of the frame, 539 and fixed thereto and then the cord line 531 that is exposed to an upper end of the loop forming fabric 530 is fitted into the cutaway portion 522 of the adjusting-rod. 520 to be pushed into the insertion hole 511 of the housing 510 that has been already inserted into the winding-rod 537.

At this time, the cord line 531 is in close contact between an internal surface of the insertion hole 511 and the taper portion 521 while it is fitted into the cutaway portion 522 of the adjusting-rod 520. When the adjusting-rod 520 is fitted to an extent not being further inserted, the cord line 531 is in complete close contact between an internal surface of the insertion hole 511 and the taper portion 521 not to be retracted unless the adjusting-rod 520 is separated from the insertion hole 511. The adjusting-rod 520 has a taper portion 521 that is slanted in a longitudinal direction. As an outer diameter of the adjusting-rod 520 is increased gradually, an inner diameter of the insertion hole 511 is decreased gradually so that the cord line 531 is compressed gradually. As a result, the cord line 531 is disposed between the adjusting-rod 520 and the inserting hole 511 to be in close contact and fixed thereto by the compression force.

Each cord line 531 is fixed to the housing 510 by using the adjusting-rod 520, which is fixed corresponding to the left and right intervals and the number of the cord line 531 and thus each upper end of the loop forming fabric 530 and the roll-up fabric 536 is assembled completely.

Further, referring to FIG. 39b, the cord line 531 that is exposed to a lower end of the loop forming fabric 530 is fixed such that firstly the mould 536b at a lower end of the roll-up fabric 536 is fitted into the mounting groove 542b of the weight 542, similarly to a related art, and then the housing 510 and the adjusting-rod. 520 are fitted into the mounting groove 542b of the weight 542 to be assembled, in the same manner as described above.

However, it is enough to fix simply the cord line 531 at a side of the winding rod 537 and thus it does not need to adjust separately the length of the cord line, but it needs to adjust the length of the cord line 531 at a side of the weight 542.

Accordingly, when intending to adjust the length of the cord line 531 while the adjusting-rod 520 is fitted into the insertion hole 511 of the housing 510, the adjusting-rod 520 is retracted slightly from the insertion hole 511 to an extent that the adjust-rod 520 can rotate freely within the insertion hole 511 and then a driver (not shown) is put into the groove for tool 525 formed on the head portion 524 of the adjusting-rod 520. By using the driver, the adjusting-rod 520 is rotated and the cord line 531 is wound around the taper portion 521 to adjust the length of the cord line 531 such that the loose cord line 531 is be strained tensely, and then the adjusting-rod 520 is pushed completed into the insertion ho e 511, thereby completing a fixing operation of the cord line 531.

The foregoing is illustrative of example embodiments and is not to be construed as limiting thereof. Although example embodiments have been described, those skilled in the art will readily appreciate that many substitutions, modifications and changes may be made to these embodiments without materially departing from the principles and sprit of the invention.

1. A Roman shade type blind cloth wherein two or more ring sets into which a cord line is inserted are woven integrally when weaving a fabric to be formed repeatedly along a vertical direction and a horizontal direction within a predetermined interval l on a back surface of the blind cloth.

2. The Roman shade type blind cloth of claim 1, wherein the ring sets have a predetermined width b and a weft is woven not to be entangled with a warp by the width b of the ring sets when weaving the blind cloth.

3. The Roman shade type blind cloth of claim 1, wherein the ring sets have a predetermined width b and a warp is woven not to be entangled with a weft by the width b of the ring sets when weaving the blind cloth.

4. The Roman shade type blind cloth of claim 3, wherein a blind cloth is woven such that the ring sets are formed by arranging a distance between the warps which are not entangled with the wept to be increased gradually when weaving the blind cloth.

5. A Roman shade type blind cloth wherein all of wefts are woven not to be entangled with warps by the width b of the ring such that rings into which a cord line is inserted are formed consecutively in a vertical direction on a back surface of the blind cloth.

6. A Roman shade type blind cloth wherein all of warps are woven not to be entangled with wefts by the width b of the ring such that rings into which a cord line is inserted are formed consecutively in a horizontal direction on a back surface of the blind cloth.

7. The Roman shade type blind cloth of claim 6, wherein rings are formed by arranging a distance between warps which are not entangled with wefts to be increased gradually when weaving the blind cloth.

8. A Roman shade type blind cloth, wherein wefts are woven not to be entangled with warps by the width b of the ring such that rings into which a cord line is inserted are formed on a back surface of the blind cloth, is characterized in that pockets consisting of internal fabric and external fabric are formed repeatedly on the blind cloth and one or more rings are formed on the external fabric that is disposed toward a window.

9. A Roman shade type blind cloth, wherein warps are woven not to be entangled with wefts by the width b of the ring such that rings into which a cord line is inserted are formed on a back surface of the blind cloth, is characterized in that pockets consisting of internal fabric and external fabric are formed repeatedly on the blind cloth and one or more rings are formed on the external fabric that is disposed toward a window.

10. The Roman shade type blind cloth of claim 9, wherein rings are formed by arranging a distance between warps which are not entangled with wefts to be increased gradually when weaving the blind cloth.

11. The Roman shade type blind cloth of claim 1, wherein fabric of a blind cloth is woven integrally by supplying a cord line as a warp and fitting the cord line into a ring when the ring is formed while the blind cloth is woven.

12. The roman shade type blind cloth of claim 8, wherein internal and external fabrics are woven consecutively in the blind cloth such that pockets are formed consecutively by a boundary portion.

13. The Roman shade type blind cloth of claim 8, wherein the blind cloth is woven such that two or more rings are formed repeatedly within a predetermined interval l of external fabric of the blind cloth.

14. The Roman shade type blind cloth of claim 1, wherein the blind cloth consists only of light-transmitting parts or light-shielding parts.

15. The Roman shade type blind cloth of claim 1, wherein the blind cloth consists of light-transmitting parts and light-shielding parts that are arranged consecutively and repeatedly.

16. The Roman shade type blind cloth of claim 7, wherein the blind cloth consists of light-transmitting parts and light-shielding parts that are arranged consecutively and repeatedly, and the blind cloth is woven such that a pocket consisting of internal fabric and external fabric is formed on an upper end of the light-shielding part of the blind cloth.

17. The Roman shade type blind cloth of claim 15, wherein a ring is formed on an upper end of each light-shielding part of the blind cloth.

18. A blind using a Roman shade type blind cloth, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that the blind cloth is woven such that two or more ring sets are formed repeatedly within a predetermined interval t on a back surface of the front blind cloth, having an interval of a predetermined distance L2, wherein the cord line that has been inserted into the ring is woven integrally with a blind cloth fabric and the blind cloth between the ring sets is folded frontward by pulling the cord line to form a loop of a predetermined length L2/2.

19. A blind using a Roman shade type blind cloth, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that two or more ring sets are woven to be formed repeatedly within a predetermined interval t on a back surface of the front blind cloth, having an interval of a predetermined distance L2 wherein the cord line is passed through two or more rings in turn and the blind cloth between the ring sets is folded frontward by pulling the cord line to form a loop of a predetermined length L2/2.

20. A blind using a Roman shade type blind cloth, wherein an upper end of a blind cloth is fixed to a frame and a lower end thereof is fixed to a weight; and a cord line that operates the front blind cloth to form a loop passes through a back surface of the blind cloth and the upper end thereof is fixed to a winding-rod and the lower end thereof is fixed to the weight, is characterized in that all of wefts are woven not to be entangled with warps by a width b of the ring such that rings are formed consecutively on a back surface of the blind cloth in a vertical direction, and then the cord line is inserted into the rings as many as a predetermined length (L1) of the rings and a distance between the rings is maintained with a predetermined length (L2), and the blind cloth between the rings is folded frontward by pulling the cord line to form a loop of a predetermined length L2/2.

21. A blind using a Roman shade type blind cloth, wherein an upper end of a front blind cloth is fixed to a frame and a lower end thereof is fixed to a weight; an upper end of a rear blind cloth is fixed to a winding-rod rotatably mounted on the frame and a lower end thereof is fixed to the weight, respectively; and a cord line that operates the front blind cloth to form a loop passes through a back surface of the front blind cloth and the upper end thereof is fixed to the winding-rod and the lower end thereof is fixed to the weight, is characterized in that pockets consisting of internal fabric and external fabric are formed repeatedly on the front blind cloth and wefts are woven not to be entangled with warps by a width b of the ring such that one or more ring sets into which the cord line is inserted are formed within a predetermined interval l on the external fabric, and then the cord line is passed through one or more ring sets in turn and the blind cloth between the ring sets is folded frontward by pulling the cord line to form a loop of a predetermined length L2/2.

22. The blind using a Roman shade type blind cloth of claim 18, wherein the front and back blind cloths are simultaneously fixed to one weight.

23. The blind using a Roman shade type blind cloth of claim 18, wherein two weights are separately fixed to the front and back blind cloths, respectively.

24. The blind using a Roman shade type blind cloth of claim 18, wherein the weight comprises: two semicircular rods that are divided, to which the lower ends of the front and back blind cloths are fixed, respectively; a lower rod cap on which fitting protrusions are protruded to face each other, which are fitted into assembly holes of respective semicircular rods not to be separated to both sides and balance the center so as to maintain a circular shape of two semicircular rods when they are assembled to one circular rod; a lower bar that is fitted into the outside of the semicircular rods in a longitudinal direction to balance the center of weights and cover the lower rod; and a lower bar cap which is fitted into both ends of the lower rod for the semicircular rods not to be separated to one side and on which an axial rod is protruded to maintain the rotation center of the semicircular rods.

25. The blind using a Roman shade type blind cloth of claim 18, wherein an interval maintaining member through which a cord line passes is arranged on each ring set of the front blind cloth.

26. The blind using a Roman shade type blind cloth of claim 25, wherein the interval maintaining member is formed as any one of a circular tube, a polygonal tube or a ring pin-shaped tube.

27. The blind using a Roman shade type blind cloth of claim 18, wherein the front blind cloth or back blind cloth consists only of light-transmitting parts or light-shielding parts.

28. The blind using a Roman shade type blind cloth of claim 18, wherein the light-transmitting part and the light-shielding part are formed consecutively on the front and back blind cloths, respectively, for each light-transmitting part and light-shielding part to be corresponded to or separated from each other.

29. The blind using a Roman shade type blind cloth of claim 28, wherein the ring sets are formed on the upper end of each light-shielding part of the front blind cloth.

30. The blind using a Roman shade type blind cloth of claim 21, wherein internal and external fabrics are woven consecutively on the blind cloth such that pockets are formed consecutively by a boundary portion.

31. The blind using a Roman shade type blind cloth of claim 21, wherein tension bands are fitted into the pockets at set locations of the front blind cloth so as to maintain the tension states of internal and external fabrics.

32. A blind using a Roman shade type blind cloth, wherein an upper end of a blind cloth is fixed to a frame and the lower end thereof is fixed to a weight; and a cord line that operates the blind cloth to form a loop passes through a back surface of the blind cloth and the upper end thereof is fixed to the winding-rod and the lower end thereof is fixed to the weight, is characterized in that pockets consisting of internal fabric and external fabric are formed repeatedly on the blind cloth and wefts are woven not to be entangled with warps by a width b of the ring such that one or more ring sets into which the cord line is inserted are formed within a predetermined interval t on the external fabric, and the cord line passes through one or more rings in turn and the blind cloth between the ring sets is folded frontward by pulling the cord line to form a loop of a predetermined length L2/2.

33. The blind using a Roman shade type blind cloth of claim 32, wherein the pockets of the blind cloth are formed repeatedly at predetermined intervals.

34. The blind using a Roman shade type blind cloth of claim 32, wherein internal and external fabrics are woven consecutively on the blind cloth such that the pockets are formed consecutively by a boundary portion.

35. The blind using a Roman shade type blind cloth of claim 32, wherein tension bands are fitted into the pockets at set locations of the blind cloth so as to maintain the tension states of internal and external fabrics.

36. A device for adjusting a length of a cord line of a Roman shade type blind and a device for fixing thereof, comprising: a housing at a center of which an insertion hole is formed horizontally to be fixed to a winding-rod and a weigh part, respectively; and an adjusting-rod that is inserted into the insertion hole formed on the housing, wherein the length of the cord line is fixed by forcibly putting an adjusting-rod into the insertion hole of the housing while the cord line is supported, or the length of the cord line is adjusted by rotating the adjusting-rod.

37. The device for adjusting a length of a cord line of a Roman shade type blind and a device for fixing thereof of claim 36, wherein a hook is formed on an outer circumferential surface of the housing and the hook is caught over mounting grooves formed on a winding-rod or a weight to be fixed thereto.

38. The device for adjusting a length of a cord line of a Roman shade type blind and a device for fixing thereof of claim 36, wherein a position determining groove is formed at an inlet of an insertion hole formed on the housing.

39. The device for adjusting a length of a cord line of a Roman shade type blind and a device for fixing thereof of claim 36, wherein the adjusting-rod has a taper portion that is slanted toward a remote end around which the cord line is wound such that the cord line is in close contact with the inside of the inserting hole and is fixed thereto.

40. The device for adjusting a length of a cord line of a Roman shade type blind and a device for fixing thereof of claim 36, wherein a supporting means for supporting the cord line is further provided on the adjusting-rod.

41. The device for adjusting a length of a cord line of a Roman shade type blind and a device for fixing thereof of claim 40, wherein the supporting means is formed on a front end of the taper portion of the adjusting-rod and is a cutaway portion into which the cord line is inserted.

42. The device for adjusting a length of a cord line of a Roman shade type blind and a device for fixing thereof of claim 40, wherein the supporting means is formed on the taper portion of the adjusting-rod and is a fitting hole through which the cord line passes.

43. The device for adjusting a length of a cord line of a Roman shade type blind and a device for fixing thereof of claim 39, wherein a head portion is formed on the adjusting-rod and a groove for tool is formed on the head portion.

44. The device for adjusting a length of a cord line of a Roman shade type blind and a device for fixing thereof of claim 39, wherein a catching part is further formed on the adjusting-rod.
